(19) United States
(12) Patent Application Publication
(10) Pub. No.: US 2024/0276339 A1
(43) Pub. Date: Aug. 15, 2024

(54) METHOD AND APPARATUS FOR MANAGING CELL RESELECTION PRIORITY OF TERMINAL IN NEXT-GENERATION MOBILE COMMUNICATION SYSTEM

(71) Applicant: Samsung Electronics Co., Ltd., Gyeonggi-do (KR)

(72) Inventors: Sangyeob JUNG, Gyeonggi-do (KR); Anil AGIWAL, Gyeonggi-do (KR)

(21) Appl. No.: 18/428,391

(22) Filed: Jan. 31, 2024

(30) Foreign Application Priority Data
Feb. 10, 2023 (KR) 10-2023-0018094

(51) Int. Cl. H04W 36/32; H04W 36/00

(52) U.S. Cl. CPC H04W 36/328; H04W 36/0085

(57) ABSTRACT

The disclosure relates to a fifth generation (5G) or sixth generation (6G) communication system for supporting a higher data transmission rate. The disclosure relates to a method performed by an unscrewed aerial vehicle (UAV) terminal in a wireless communication system, including receiving first system information, camping on a first cell supporting a UAV based on the first system information, in case that an altitude of the UAV terminal is greater than an altitude threshold, receiving, from the first cell, second system information including cell reselection information, determining a cell reselection priority based on a frequency identical to a first frequency of the first cell and the cell reselection information included in the second system information, and performing a measurement based on the cell reselection priority.

### CROSS-REFERENCE TO RELATED APPLICATION(S)

This application is based on and claims priority under 35 U.S.C. § 119 to Korean Patent Application No. 10-2023-0018094, filed on Feb. 10, 2023, in the Korean Intellectual Property Office, the disclosure of which is incorporated herein by reference in its entirety.

### BACKGROUND

### 1. Field

The disclosure relates generally to a terminal and a base station (BS) in a mobile communication system, and more particularly, a method and an apparatus for managing a cell reselection priority of a terminal in a next-generation mobile communication system.

### 2. Description of Related Art

Fifth generation (5G) mobile communication technologies define broad frequency bands such that high transmission rates and new services are possible and can be implemented not only in sub 6 gigahertz (GHz) bands such as 3.5 GHz, but also in above 6 GHz bands referred to as millimeter wave (mmWave) including 28 GHz and 39 GHz. In addition, it has been considered to implement sixth generation (6G) mobile communication technologies (referred to as beyond 5G systems) in terahertz (THz) bands such as 95 GHz to 3 THz bands to accomplish transmission rates fifty times faster than 5G mobile communication technologies and ultra-low latencies one-tenth of 5G mobile communication technologies.

Since the initial stage of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multi input multi output (MIMO) for mitigating radio-wave path loss and increasing radio-wave transmission distances in millimeter wave (mmWave) bands, supporting numerologies, e.g., operating multiple subcarrier spacings, for efficiently utilizing mm Wave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Discussions are ongoing regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

There is also ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR).

There is also ongoing standardization in system architecture/service regarding a 5G baseline architecture or service based interface for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

In the conventional art, aerial UEs are deficient in terms of cell reselection when in operation. Thus, there is a need in the art for a method and apparatus that cure these deficiencies in the conventional art.

### SUMMARY

This disclosure has been made to address at least the above-mentioned problems and/or disadvantages and to provide at least the advantages described below.

Accordingly, an aspect of the disclosure is to provide a method and an apparatus for managing a cell reselection priority of a terminal (e.g., an aerial UE) in a next-generation mobile communication system.

In accordance with an aspect of the disclosure, a method performed by an uncrewed aerial vehicle (UAV) terminal in a wireless communication system includes receiving first system information, camping on a first cell supporting a UAV based on the first system information, in case that an altitude of the UAV terminal is greater than an altitude threshold, receiving, from the first cell, second system information including cell reselection information, determining a cell reselection priority based on a frequency identical to a first frequency of the first cell and the cell reselection information included in the second system information, and performing a measurement based on the cell reselection priority.

In accordance with an aspect of the disclosure, a method performed by a base station supporting a UAV in a wireless communication system includes broadcasting first system information including information on an altitude threshold of a first cell of the base station, and broadcasting second system information including cell reselection information, wherein the information on the altitude threshold is used for a UAV terminal at an altitude higher than the altitude threshold to camp on the first cell, and wherein a cell reselection priority is determined based on a frequency identical to a first frequency of the first cell and the cell reselection information included in the second system information.

In accordance with an aspect of the disclosure, a UAV terminal in a wireless communication system includes a transceiver, and a controller configured to receive first system information, camp on a first cell supporting a UAV based on the first system information, in case that an altitude of the UAV terminal is greater than an altitude threshold, receive, from the first cell, second system information including cell reselection information, determine a cell reselection priority based on a frequency identical to a first frequency of the first cell and the cell reselection information included in the second system information, and perform a measurement based on the cell reselection priority.

In accordance with an aspect of the disclosure, a base station supporting a UAV in a wireless communication system includes a transceiver, and a controller configured to broadcast first system information including information on an altitude threshold of a first cell of the base station, and broadcast second system information including cell reselection information, wherein the information on the altitude threshold is used for a UAV terminal at an altitude higher than the altitude threshold to camp on the first cell, and wherein a cell reselection priority is determined based on a frequency identical to a first frequency of the first cell and the cell reselection information included in the second system information.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of an LTE system to which the disclosure is applicable;

FIG. 2 illustrates a radio protocol structure of an LTE system to which the disclosure is applicable;

FIG. 3 illustrates a structure of a next-generation mobile communication system to which the disclosure is applicable;

FIG. 4 illustrates a radio protocol structure of a next-generation mobile communication system to which the disclosure is applicable;

FIG. 5 illustrates a UE performing a cell reselection procedure in a next-generation mobile communication system according to an embodiment;

FIG. 6 illustrates a method in which UAV UE and a ground UE access a cell employing beam uptilting and a cell employing beam downtilting in a next-generation mobile communication system according to an embodiment;

FIG. 7 illustrates an aerial UE performing a cell reselection procedure in a next-generation mobile communication system according to an embodiment;

FIG. 8 illustrates an aerial UE performing a cell reselection procedure in a next-generation mobile communication system according to an embodiment;

FIG. 9 illustrates an aerial UE performing a cell reselection procedure in a next-generation mobile communication system according to an embodiment;

FIG. 10 illustrates an aerial UE performing a cell reselection procedure in a next-generation mobile communication system according to an embodiment;

FIG. 11 illustrates a UE according to an embodiment; and

FIG. 12 illustrates a base station according to an embodiment.

### DETAILED DESCRIPTION

Hereinafter, embodiments of the disclosure will be described in detail with reference to the accompanying drawings. In the drawings, the same or like elements may be designated by the same or like reference signs as much as possible. A detailed description of known functions or configurations that may make the subject matter of the disclosure unclear will be omitted for the sake of clarity and conciseness.

In the accompanying drawings, some elements may be exaggerated, omitted, or schematically illustrated. The size of each element does not completely reflect the actual size. In the drawings, identical or corresponding elements are provided with identical reference numerals.

Various advantages and features of the disclosure and ways to achieve them will be apparent by making reference to embodiments as described below in detail in conjunction with the accompanying drawings. However, the disclosure is not limited to the embodiments set forth below but may be implemented in various different forms. The following embodiments are provided only to completely disclose the disclosure and inform those skilled in the art of the scope of the disclosure.

Herein, an element is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

As used herein, the term “unit” refers to a software element or a hardware element, such as a field programmable gate array (FPGA) or an application specific integrated circuit (ASIC), which performs a predetermined function. However, the unit does not always have a meaning limited to software or hardware. The unit may be constructed either to be stored in an addressable storage medium or to execute one or more processors. Therefore, the unit includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into a smaller number of elements, or a unit, or divided into a larger number of elements, or a unit. Moreover, the elements and units or may be implemented to reproduce one or more CPUs within a device or a security multimedia card.

In the following description, a base station is an entity that allocates resources to terminals, and may be at least one of a Node B, an eNode B (eNB), a gNode B (gNB), a wireless access unit, a base station controller, and a node on a network. A terminal may include a UE, a mobile station (MS), a cellular phone, a smartphone, a computer, or a multimedia system capable of performing communication functions. The disclosure as described below may also be applied to other communication systems having similar technical backgrounds or channel types as disclosed herein, such as 5th generation mobile communication technologies (5G, new radio, and NR) developed beyond LTE-A, and 5G may be the concept that covers the exiting LTE, LTE-A, or other similar services. In addition, based on determinations by those skilled in the art, the disclosure may also be applied to other communication systems through some modifications without significantly departing from the scope of the disclosure.

Herein, terms for identifying access nodes and for referring to network entities, messages, interfaces between network entities, and various identification information are illustratively used for the sake of descriptive convenience. Therefore, the disclosure is not limited by the terms as used below, and other terms referring to subjects having equivalent technical meanings may be used.

Herein, some of terms and names defined in the 3rd generation partnership project long term evolution (3GPP LTE) standards and/or 3GPP NR standards will be used for the sake of descriptive convenience. However, the disclosure is not limited by these terms and names and may be applied in the same manner to systems that conform other standards. Herein, eNB may be interchangeably used with gNB for the sake of descriptive convenience.

Herein, an NES UE supports an NES operation or function, and NES UE may be interchangeably used with UE.

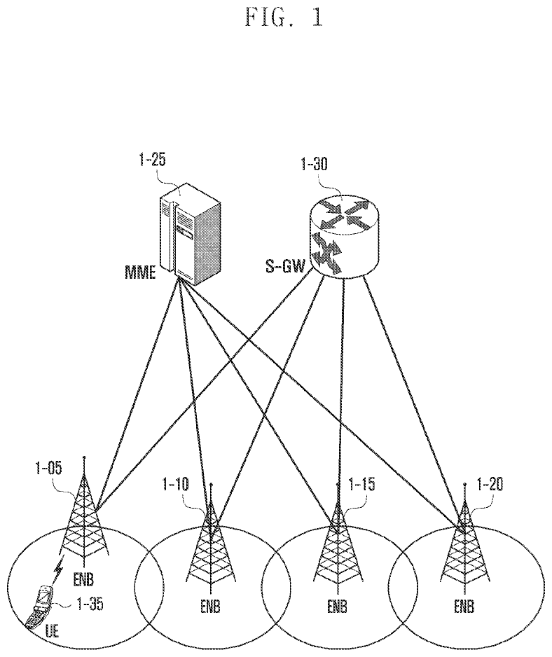

FIG. 1 illustrates a structure of an LTE system to which the disclosure is applicable.

Referring to FIG. 1, a radio access network of an LTE system includes next-generation base stations (referred to as evolved node Bs, hereinafter ENBs, node Bs, or BSs) 1-05, 1-10, 1-15, and 1-20, a mobility management entity (MME) 1-25, and a serving gateway (S-GW) 1-30. A UE 1-35 accesses an external network through the ENBs 1-05, 1-10, 1-15, and 1-20 and the S-GW 1-30.

In FIG. 1, the ENBs 1-05, 1-10, 1-15, and 1-20 correspond to conventional node Bs of a universal mobile telecommunication system (UMTS). The ENBs are connected to the UE 1-35 through a radio channel, and perform more complicated roles than the conventional node Bs. In the LTE system, since all user traffic including real-time services, such as voice over Internet protocol (VOIP), is serviced through a shared channel, a device that collects state information, such as buffer states, available transmit power states, and channel states of UEs, and performs scheduling accordingly is required, and the ENBs 1-05, 1-10, 1-15, and 1-20 may serve as the device. In general, one ENB controls multiple cells. For example, to implement a transfer rate of 100 megabits per second (Mbps), the LTE system uses orthogonal frequency division multiplexing (OFDM) as a radio access technology in a bandwidth of, for example, 20 MHz. In addition, the LTE system employs an adaptive modulation & coding (AMC) scheme for determining a modulation scheme and a channel coding rate according to the channel state of a UE. The S-GW 1-30 provides a data bearer and may generate or remove a data bearer under the control of the MME 1-25. The MME 1-25 is responsible for various control functions as well as a mobility management function for a UE and may be connected to multiple base stations.

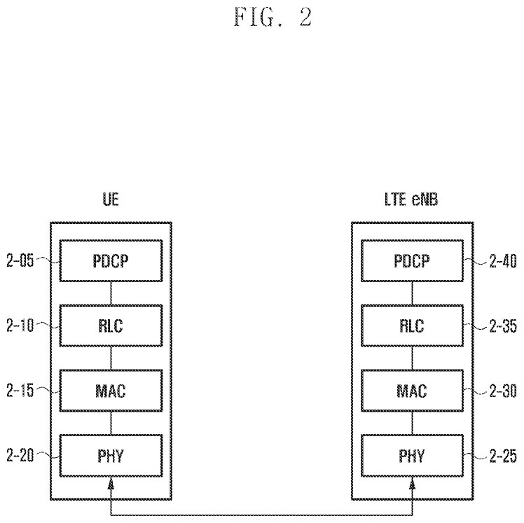

FIG. 2 illustrates a radio protocol structure in an LTE system to which the disclosure is applicable.

Referring to FIG. 2, a radio protocol of an LTE system includes a packet data convergence protocol (PDCP) 2-05 and 2-40, a radio link control (RLC) 2-10 and 2-35, and a medium access control (MAC) 2-15 and 2-30 in a UE and an ENB, respectively. The packet data convergence protocol (PDCP) 2-05 and 2-40 serves to perform operations, such as IP header compression/reconstruction. The main functions of the PDCP 2-05 and 2-40 may be summarized as follows.
Header compression and decompression (ROHC only)
Transfer of user data
In-sequence delivery (In-sequence delivery of upper layer PDUs at PDCP re-establishment procedure for RLC AM)
Reordering (For split bearers in DC (only support for RLC AM): PDCP PDU routing for transmission and PDCP PDU reordering for reception)
Duplicate detection (Duplicate detection of lower layer SDUs at PDCP re-establishment procedure for RLC AM)
Retransmission (Retransmission of PDCP SDUs at handover and, for split bearers in DC, of PDCP PDUs at PDCP data-recovery procedure, for RLC AM)
Ciphering and deciphering
Timer-based SDU discard (Timer-based SDU discard in uplink)

The radio link control (hereinafter referred to as RLC) 2-10 or 2-35 reconfigures a PDCP protocol data unit (PDU) into an appropriate size to perform an ARQ operation. The main functions of the RLC 2-10 or 2-35 may be summarized as follows.
Data transfer (Transfer of upper layer PDUs)
ARQ (Error Correction through ARQ (only for AM data transfer))
Concatenation, segmentation and reassembly (Concatenation, segmentation and reassembly of RLC SDUs (only for UM and AM data transfer))
Re-segmentation (Re-segmentation of RLC data PDUs (only for AM data transfer))
Reordering (Reordering of RLC data PDUs (only for UM and AM data transfer))
Duplicate detection (only for UM and AM data transfer)
Error detection (Protocol error detection (only for AM data transfer))
RLC SDU discard (only for UM and AM data transfer)
RLC re-establishment

The MAC 2-15 or 2-30 is connected to several RLC layer devices configured in a single terminal, and multiplexes RLC PDUs to a MAC PDU and demultiplexes a MAC PDU to RLC PDUs. The main functions of the MAC 2-15 or 2-30 are summarized as follows.
Mapping (Mapping between logical channels and transport channels)
Multiplexing and demultiplexing (Multiplexing/demultiplexing of MAC SDUs belonging to one or different logical channels into/from transport blocks (TB) delivered to/from the physical layer on transport channels)
Scheduling information reporting
HARQ (Error correction through HARQ)
Priority handling between logical channels (Priority handling between logical channels of one UE)
Priority handling between UEs (Priority handling between UEs by means of dynamic scheduling)
MBMS service identification
Transport format selection
Padding

A physical (PHY) layer 2-20 and 2-25 performs channel coding and modulation of higher layer data, makes the data into OFDM symbols, and transmits the OFDM symbols through a wireless channel, or performs demodulation and channel decoding of OFDM symbols received through a wireless channel and then transfers the OFDM symbols to a higher layer.

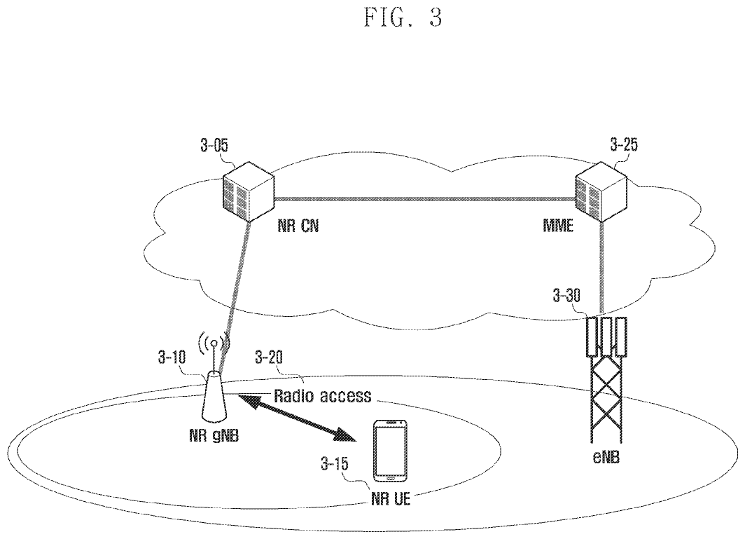

FIG. 3 illustrates a structure of a next-generation mobile communication system to which the disclosure is applicable.

Referring to FIG. 3, a radio access network of a next-generation mobile communication system (hereinafter NR or 5G) includes a next-generation base station (new radio node B, hereinafter NR gNB or NR BS) 3-10, and a new radio core network (NR CN) 3-05. A user terminal (new radio UE, hereinafter NR UE or NR terminal) 3-15 accesses an external network via the NR gNB 3-10 and the NR CN 3-05.

In FIG. 3, the NR gNB 3-10 corresponds to an evolved node B (eNB) of a conventional LTE system. The NR gNB 3-10 is connected to the NR UE 3-15 through a radio channel and may provide outstanding services as compared to a conventional node B. In the next-generation mobile communication system, since all user traffic is serviced through a shared channel, the NR NB 3-10 serves as the device that collects state information, such as buffer statuses, available transmit power states, and channel states of UEs, and performs scheduling accordingly. In general, one NR gNB 3-10 controls multiple cells. To implement ultrahigh-speed data transfer beyond the current LTE, the next-generation mobile communication system may provide a wider bandwidth than the existing maximum bandwidth, may employ OFDM as a radio access technology, and may additionally integrate a beamforming technology therewith. The next-generation mobile communication system employs an AMC scheme for determining a modulation scheme and a channel coding rate according to a channel state of a UE. The NR CN 3-05 performs functions such as mobility support, bearer configuration, and quality of service (QOS) configuration. The NR CN 3-05 is responsible for various control functions as well as a mobility management function for a UE, and is connected to multiple base stations. In addition, the next-generation mobile communication system may interwork with the existing LTE system, and the NR CN 3-05 is connected to an MME 3-25 via a network interface. The MME 3-25 is connected to an eNB 3-30 that is an existing base station.

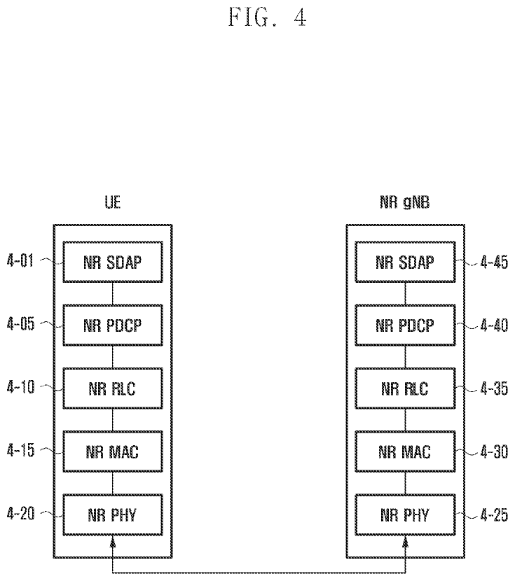

FIG. 4 illustrates a radio protocol structure of a next-generation mobile communication system to which the disclosure is applicable.

Referring to FIG. 4, a radio protocol of a next-generation mobile communication system includes an NR SDAP 4-01 and 4-45, an NR PDCP 4-05 and 4-40, an NR RLC 4-10 and 4-35, and an NR MAC 4-15 and 4-30 in a UE and an NR base station, respectively.

The main functions of the NR SDAP 4-01 or 4-45 may include some of the functions below.

Transfer of user data (transfer of user plane data)

Mapping between a QoS flow and a data bearer for uplink and downlink (mapping between a QoS flow and a DRB for both DL and UL)

Marking a QoS flow ID in uplink and downlink (marking QoS flow ID in both DL and UL packets)

Mapping a reflective QoS flow to a data bearer with respect to UL SDAP PDUs (reflective QoS flow to DRB mapping for the UL SDAP PDUs)

Whether to use a header of the SDAP layer device, or whether to use a function of the SDAP layer device may be configured for the UE with respect to the SDAP layer device through an RRC message for each PDCP layer device, each bearer, or each logical channel. Furthermore, in a case where an SDAP header is configured, an NAS QoS reflective configuration one-bit indicator (NAS reflective QoS) and an As QoS reflective configuration one-bit indicator (As reflective QoS) of the SDAP header may indicate the terminal to update or reconfigure mapping information relating to a QoS flow and a data bearer for uplink and downlink. The SDAP header may include QoS flow ID information indicating a QoS. The QoS information may be used as data processing priority, scheduling information, etc. for smoothly supporting the service.

The main functions of the NR PDCP 4-05 or 4-40 may include some of functions below.
Header compression and decompression (ROHC only)
Transfer of user data
In-order delivery (In-order delivery of upper layer PDUs)
Out-of-order delivery (Out-of-order delivery of upper layer PDUs)
Reordering (PDCP PDU reordering for reception)
Duplicate detection (Duplicate detection of lower layer SDUs)
Retransmission (Retransmission of PDCP SDUs)
Ciphering and deciphering
Timer-based SDU discard (Timer-based SDU discard in uplink)

The reordering of the NR PDCP device refers to a function of reordering PDCP PDU received from a lower layer in an order based on PDCP sequence numbers (SNs), and may include a function of transferring data to a higher layer according to a rearranged order, may include a function of directly transferring data without considering order, may include a function of rearranging order to record lost PDCP PDUs, may include a function of reporting the state of lost PDCP PDUs to a transmission side, or may include a function of requesting retransmission of lost PDCP PDUS.

The main functions of the NR RLC 4-10 or 4-35 may include some of functions below.
Data transfer (Transfer of upper layer PDUs)
In-order delivery (In-order delivery of upper layer PDUs)
Out-of-order delivery (Out-of-order delivery of upper layer PDUs)
ARQ (Error correction through ARQ)
Concatenation, segmentation and reassembly (Concatenation, segmentation and reassembly of RLC SDUs)
Re-segmentation (Re-segmentation of RLC data PDUs)
Reordering (Reordering of RLC data PDUs)
Duplicate detection
Error detection (Protocol error detection)
RLC SDU discard
RLC re-establishment

The in-order delivery of the NR RLC device may indicate a function of transferring RLC SDUs received from a lower layer to a higher layer in sequence. Furthermore, the in-order delivery may include a function of, if one original RLC SDU is divided into several RLC SDUs and then the RLC SDUs are received, reassembling the several RLC SDUs and transferring the reassembled RLC SDUs, may include a function of rearranging received RLC PDUs with reference to RLC sequence numbers (SNs) or PDCP sequence numbers (SNs), may include a function of rearranging order to record lost RLC PDUs, may include a function of reporting the state of lost RLC PDUs to a transmission side, may include a function of requesting retransmission of lost RLC PDUs, may include a function of, if there is a lost RLC SDU, sequentially transferring only RLC SDUs before the lost RLC SDU to a higher layer, may include a function of, although there is a lost RLC SDU, if a predetermined timer has expired, sequentially transferring, to a higher layer, all the RLC SDUs received before the timer is started, or may include a function of, although there is a lost RLC SDU, if a predetermined timer has expired, sequentially transferring all the RLC SDUs received up to the current, to a higher layer. In addition, the NR RLC device may process RLC PDUs in a reception order (an order in which the RLC PDUs have arrived, regardless of an order based on sequence numbers) and then transfer the processed RLC PDUs to a PDCP device regardless of order (out-of-order delivery). In a case of segments, the NR RLC device may receive segments stored in a buffer or to be received in the future, reconfigure the segments to be one whole RLC PDU, then process the RLC PDU, and transfer the processed RLC PDU to a PDCP device. The NR RLC layer may not include a concatenation function, and the concatenation function may be performed in an NR MAC layer or replaced with a multiplexing function of an NR MAC layer.

The out-of-sequence delivery function of the NR RLC device may indicate a function of immediately transferring RLC SDUs received from a lower layer, to an upper layer regardless of the order thereof. Furthermore, the out-of-sequence delivery function may include a function of, if one original RLC SDU is divided into several RLC SDUs and then the RLC SDUs are received, reassembling the several RLC SDUs and transferring the reassembled RLC SDUs, and may include a function of storing an RLC sequence number (SN) or a PDCP sequence number (SN) of received RLC PDUs and arranging order to record lost RLC PDUs.

The NR MAC 4-15 or 4-30 may be connected to several NR RLC layer devices configured in a single UE, and the main functions of the NR MAC may include some of functions below.
Mapping (Mapping between logical channels and transport channels)
Multiplexing and demultiplexing (Multiplexing/demultiplexing of MAC SDUs)
Scheduling information reporting
HARQ (Error correction through HARQ)
Priority handling between logical channels (Priority handling between logical channels of one UE)
Priority handling between UEs (Priority handling between UEs by means of dynamic scheduling)
MBMS service identification
Transport format selection
Padding

An NR PHY layer 4-20 or 4-25 may perform channel coding and modulation of higher layer data to make the data into OFDM symbols and transmit the OFDM symbols through a wireless channel, or may perform demodulation and channel decoding of OFDM symbols received through a wireless channel, and then transfer the OFDM symbols to a higher layer.

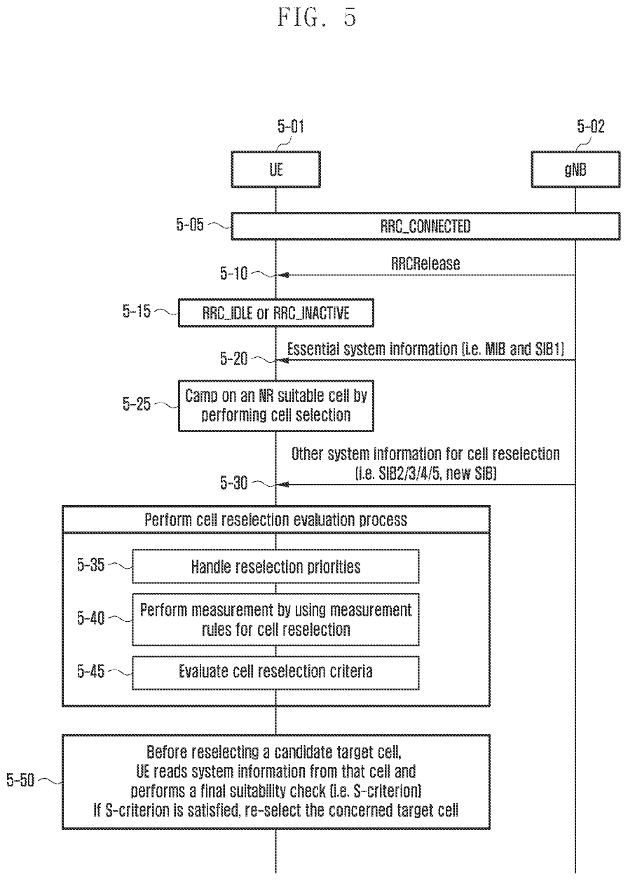

FIG. 5 illustrates a UE performing a cell reselection procedure in a next generation mobile communication system according to an embodiment.

Referring to FIG. 5, in step 5-05, a UE 5-01 may be in an RRC connected mode (RRC_CONNECTED) by establishing an RRC connection with an NR base station 5-02.

In step 5-10, an NR base station 5-02 may transmit an RRC release message (RRCRelease) to the UE 5-01.

In step 5-20, upon receiving the RRCRelease, the UE 5-01 may transition to an RRC idle mode or RRC inactive mode. Specifically, In case that receiving the RRCRelease containing suspend configuration information (suspendConfig) in step 5-10, the UE transitions to the RRC inactive mode. In case that receiving the RRCRelease that does not include the suspend configuration information), the UE may transition to the RRC idle mode.

In step 5-25, the UE 5-01 in the RRC idle mode or RRC inactive mode may acquire essential system information. The essential system information may refer to a master information block (MIB) and system information block 1 (SIB1).

In step 5-30, the UE 5-01 in the RRC idle mode or RRC inactive mode may camp on an NR suitable cell by performing a cell selection procedure. The cell on which the UE has camped may be referred to as a serving cell.

In the disclosure, in case that the conditions in Table 1 below are fulfilled based on the 3GPP standard document 38.304, the cell may be defined as a suitable cell.

TABLE 1
suitable cell:

```
For UE not operating in SNPN Access Mode, a cell
is considered as suitable if the following
conditions are fulfilled:
  -The cell is part of either the selected PLMN
  or the registered PLMN or PLMN of the
  Equivalent PLMN list, and for that PLMN either:
  -The PLMN-ID of that PLMN is broadcast by
  the cell with no associated CAG-IDs and CAG-
  only indication in the UE for that PLMN (TS
  23.501 [10]) is absent or false;
  -Allowed CAG list in the UE for that PLMN
  (TS 23.501 [10]) includes a CAG-ID broadcast
  by the cell for that PLMN;
  -The cell selection criteria are fulfilled, see
  clause 5.2.3.2.
  According to the latest information provided
  by NAS:
  -The cell is not barred, see clause 5.3.1;
  -The cell is part of at least one TA that is not
  part of the list of ″Forbidden Tracking Areas for
  Roaming″ (TS 22.011 [18]), which belongs to
  a PLMN that fulfils the first bullet above.
  For UE operating in SNPN Access Mode, a
  cell is considered as suitable if the following
  conditions are fulfilled:
  -The cell is part of either the selected SNPN or
  the registered SNPN of the UE;
  -The cell selection criteria are fulfilled, see
  clause 5.2.3.2;
  According to the latest information provided by
  NAS:
  -The cell is not barred, see clause 5.3.1;
  -The cell is part of at least one TA that is not
  part of the list of ″Forbidden Tracking Areas for
  Roaming″ which belongs to either the selected
  SNPN or the registered SNPN of the UE.
```

For reference, in case that the following first expression is satisfied, the UE may determine that cell selection criteria are fulfilled.

$$Srxlev > 0 AND Squal > 0 \\ where \\ Srxlev = {Q}_{rxlevmeas} - ( {Q}_{rxlevmin} + {Q}_{rxlevminoffset} ) - {P}_{compensation} - {Qoffset}_{temp} , \\ Squal = {Q}_{qualmeas} - ( {Q}_{qualmin} + {Q}_{qualminoffset} ) - {Qoffset}_{temp} .$$

The definition of parameters used therein refers to the 3GPP standard document “38.304: UE procedures in Idle mode and RRC Inactive state”.

In step 5-35, the UE 5-01 in the RRC idle mode or RRC inactive mode may acquire system information (for example, SIB2, SIB3, SIB4, and SIB5) including cell reselection information from the serving cell 5-02 to perform a cell reselection evaluation procedure. The SIB2 may include information/parameters commonly applied to reselect NR intra-frequency, NR inter-frequency, and inter-radio access technology (RAT) frequency cells by the UE and NR intra-frequency cell reselection information except for information related to an NR intra-frequency neighboring cell. For example, the SIB2 may include one cell reselection priority configuration information for a serving NR frequency (a frequency to which the cell on which the UE is currently camping belongs). The cell reselection priority configuration information may refer to cellReselectionPriority and cellReselectionSubPriority. Specifically, the cellReselectionPriority may receive an integer value (for example, one integer value from 0 to 7), and the cellReselectionSubPriority may receive a decimal value (for example, one decimal value among 0.2, 0.4, 0.6, and 0.8). In case that both the cellReselectionPriority and cellReselectionSubPriority are signaled, the UE 5-01 may derive a cell reselection priority value by adding the two values. For reference, a larger cell reselection priority value refers to a higher priority. Specifically, cell reselection configuration information broadcast in SIB2 may be as shown below in Table 2.

TABLE 2

| | |
|---|---|
| SIB2 ::= | SEQUENCE { |
| cellReselectionInfoCommon | SEQUENCE { |

| | |
|---|---|
| nrofSS-BlocksToAverage | INTEGER (2..maxNrofSS- |

BlocksToAverage) OPTIONAL, -- Need S

| | |
|---|---|
| absThreshSS-BlocksConsolidation | ThresholdNR |

OPTIONAL, -- Need S

| | |
|---|---|
| rangeToBestCell | RangeToBestCell |

OPTIONAL, -- Need R

| | |
|---|---|
| q-Hyst | ENUMERATED { |

dB0, dB1, dB2, dB3, dB4, dB5, dB6,

dB8, dB10,

dB12, dB14, dB16, dB18, dB20, dB22,

dB24},

| | |
|---|---|
| speedStateReselectionPars | SEQUENCE { |

| | |
|---|---|
| mobilityStateParameters | MobilityStateParameters, |
| q-HystSF | SEQUENCE { |

| | |
|---|---|
| sf-Medium | ENUMERATED {dB-6, dB-4, dB-2, |

dB0},

| | |
|---|---|
| sf-High | ENUMERATED {dB-6, dB-4, dB-2, |

```
dB0}
      }
    }
OPTIONAL, -- Need R
  ...
  },
```

| | |
|---|---|
| cellReselectionServingFreqInfo | SEQUENCE { |

| | |
|---|---|
| s-NonIntraSearchP | ReselectionThreshold |

OPTIONAL, -- Need S

| | |
|---|---|
| s-NonIntraSearchQ | ReselectionThresholdQ |

OPTIONAL, -- Need S

| | |
|---|---|
| threshServingLowP | ReselectionThreshold, |

| | |
|---|---|
| threshServingLowQ | Reselection ThresholdQ |

OPTIONAL, -- Need R

| | |
|---|---|
| cellReselectionPriority | CellReselectionPriority, |

| | |
|---|---|
| cellReselectionSubPriority | CellReselectionSubPriority |

```
OPTIONAL, -- Need R
    ...
  },
```

| | |
|---|---|
| intraFreqCellReselectionInfo | SEQUENCE { |

| | |
|---|---|
| q-RxLevMin | Q-RxLevMin, |

| | |
|---|---|
| q-RxLevMinSUL | Q-RxLevMin |

OPTIONAL, -- Need R

| | |
|---|---|
| q-QualMin | Q-QualMin |

OPTIONAL, -- Need S

| | |
|---|---|
| s-IntraSearchP | ReselectionThreshold, |

| | |
|---|---|
| s-IntraSearchQ | ReselectionThresholdQ |

OPTIONAL, -- Need S

| | |
|---|---|
| t-ReselectionNR | T-Reselection, |

| | |
|---|---|
| frequencyBandList | MultiFrequencyBandListNR-SIB |

OPTIONAL, -- Need S

| | |
|---|---|
| frequencyBandListSUL | MultiFrequencyBandListNR-SIB |

OPTIONAL, -- Need R

| | |
|---|---|
| p-Max | P-Max |

OPTIONAL, -- Need S

| | |
|---|---|
| smtc | SSB-MTC |

OPTIONAL, -- Need S

| | |
|---|---|
| ss-RSSI-Measurement | SS-RSSI-Measurement |

OPTIONAL, -- Need R

| | |
|---|---|
| ssb-ToMeasure | SSB-ToMeasure |

OPTIONAL, -- Need S

| | |
|---|---|
| deriveSSB-IndexFromCell | BOOLEAN, |

```
    ...,
    [[
```

| | |
|---|---|
| t-ReselectionNR-SF | SpeedStateScaleFactors |

```
OPTIONAL -- Need N
    ]],
    [[
```

| | |
|---|---|
| smtc2-LP-r16 | SSB-MTC2-LP-r16 |

OPTIONAL, -- Need R

| | |
|---|---|
| ssb-PositionQCL-Common-r16 | SSB-PositionQCL-Relation-r16 |

```
OPTIONAL -- Cond SharedSpectrum
    ]]
  },
  ...,
  [[
```

| | |
|---|---|
| relaxedMeasurement-r16 | SEQUENCE { |

| | |
|---|---|
| lowMobilityEvaluation-r16 | SEQUENCE { |

| | |
|---|---|
| s-SearchDeltaP-r16 | ENUMERATED { |

dB3, dB6, dB9, dB12, dB15,
spare3, spare2, spare1 },

| | |
|---|---|
| t-SearchDeltaP-r16 | ENUMERATED { |

s5, s10, s20, s30, s60, s120, s180,
s240, s300, spare7, spare6,

spare5,

spare4, spare3, spare2, spare1 }

OPTIONAL, -- Need R

| | |
|---|---|
| cellEdgeEvaluation-r16 | SEQUENCE { |

| | |
|---|---|
| s-SearchThresholdP-r16 | ReselectionThreshold, |

| | |
|---|---|
| s-SearchThresholdQ-r16 | ReselectionThresholdQ |

OPTIONAL -- Need R
}
OPTIONAL, -- Need R

| | |
|---|---|
| combineRelaxedMeasCondition-r16 | ENUMERATED {true} |

OPTIONAL, -- Need R

| | |
|---|---|
| highPriorityMeasRelax-r16 | ENUMERATED {true} |

```
OPTIONAL -- Need R
  }
OPTIONAL -- Need R
  ]]
}
RangeToBestCell ::= Q-OffsetRange
```

The SIB3 may include neighboring cell information/parameters for reselecting an NR intra-frequency cell by the UE. For example, via the SIB3, an NR intra-frequency cell list (intraFreqNeighCellList) for reselecting an NR intra-frequency cell or a cell list (intraFreqBlackCellList) in which NR intra-frequency cell reselection is not allowed may be broadcast. Specifically, information in Table 3 below may be broadcast in SIB3.

TABLE 3

| | |
|---|---|
| SIB3 ::= | SEQUENCE { |

| | |
|---|---|
| intraFreqNeighCellList | IntraFreqNeighCellList |

OPTIONAL, -- Need R

| | |
|---|---|
| intraFreqBlackCellList | IntraFreqBlackCellList |

OPTIONAL, -- Need R

| | |
|---|---|
| lateNonCriticalExtension | OCTET STRING |

```
OPTIONAL,
  ...,
  [[
```

| | |
|---|---|
| intraFreqNeighCellList-v1610 | IntraFreqNeighCellList-v1610 |

OPTIONAL, -- Need R

| | |
|---|---|
| intraFreqWhiteCellList-r16 | IntraFreqWhiteCellList-r16 |

OPTIONAL, -- Cond SharedSpectrum2

| | |
|---|---|
| intraFreqCAG-CellList-r16 | SEQUENCE (SIZE (1..maxPLMN)) OF |

| | |
|---|---|
| IntraFreqCAG-CellListPerPLMN-r16 | OPTIONAL -- Need R |

]]
}

| | |
|---|---|
| IntraFreqNeighCellList ::= | SEQUENCE (SIZE (1..maxCellIntra)) OF |

IntraFreqNeighCellInfo

| | |
|---|---|
| IntraFreqNeighCellList-v1610 ::= | SEQUENCE (SIZE (1..maxCellIntra)) OF |

IntraFreqNeighCellInfo-v1610

| | |
|---|---|
| IntraFreqNeighCellInfo ::= | SEQUENCE { |

| | |
|---|---|
| physCellId | PhysCellId, |
| q-OffsetCell | Q-OffsetRange, |

| | |
|---|---|
| q-RxLevMinOffsetCell | INTEGER (1..8) |

OPTIONAL, -- Need R

| | |
|---|---|
| q-RxLevMinOffsetCellSUL | INTEGER (1..8) |

OPTIONAL, -- Need R

| | |
|---|---|
| q-QualMinOffsetCell | INTEGER (1..8) |

OPTIONAL, -- Need R
...
}

| | |
|---|---|
| IntraFreqNeighCellInfo-v1610 ::= | SEQUENCE { |

| | |
|---|---|
| ssb-PositionQCL-r16 | SSB-PositionQCL-Relation-r16 |

OPTIONAL -- Cond SharedSpectrum2
}

| | |
|---|---|
| IntraFreqBlackCellList ::= | SEQUENCE (SIZE (1..maxCellBlack)) OF PCI-Range |
| IntraFreqWhiteCellList-r16 ::= | SEQUENCE (SIZE (1..maxCellWhite)) OF PCI-Range |

IntraFreqCAG-CellListPerPLMN-r16 ::= SEQUENCE {

| | |
|---|---|
| plmn-IdentityIndex-r16 | INTEGER (1..maxPLMN), |
| cag-CellList-r16 | SEQUENCE (SIZE (1..maxCAG-Cell-r16)) OF |

PCI-Range
}

The SIB4 may include information/parameters for reselecting an NR inter-frequency cell by the UE. For example, one or a plurality of NR inter-frequencies may be broadcast in the SIB4, and one cell reselection priority configuration information for each NR inter-frequency may be broadcast. The cell reselection priority configuration information for each NR inter-frequency refers to the above-mentioned content (for example, cellReselectionPriority and/or cellReselectionSubPriority mapped to each NR inter-frequency), but one cell reselection priority configuration information for each inter-frequency is optionally broadcast. Specifically, information in Table 4 below may be broadcast in SIB4.

TABLE 4

| | |
|---|---|
| SIB4 ::= | SEQUENCE { |
| interFreqCarrierFreqList | InterFreqCarrierFreqList, |

| | |
|---|---|
| lateNonCriticalExtension | OCTET STRING |

```
OPTIONAL,
  ...,
  [[
```

| | |
|---|---|
| interFreqCarrierFreqList-v1610 | InterFreqCarrierFreqList-v1610 |

OPTIONAL -- Need R
]]
}

| | |
|---|---|
| InterFreqCarrierFreqList ::= | SEQUENCE (SIZE (1..maxFreq)) OF |

InterFreqCarrierFreqInfo

| | |
|---|---|
| InterFreqCarrierFreqList-v1610 ::= | SEQUENCE (SIZE (1..maxFreq)) OF |

InterFreqCarrierFreqInfo-v1610

| | |
|---|---|
| InterFreqCarrierFreqInfo ::= | SEQUENCE { |

| | |
|---|---|
| dl-CarrierFreq | ARFCN-ValueNR, |

| | |
|---|---|
| frequencyBandList | MultiFrequencyBandListNR-SIB |

OPTIONAL, -- Cond Mandatory

| | |
|---|---|
| frequencyBandListSUL | MultiFrequencyBandListNR-SIB |

OPTIONAL, -- Need R

| | |
|---|---|
| nrofSS-BlocksToAverage | INTEGER (2..maxNrofSS-BlocksToAverage) |

OPTIONAL, -- Need S

| | |
|---|---|
| absThreshSS-BlocksConsolidation | ThresholdNR |

OPTIONAL, -- Need S

| | |
|---|---|
| smtc | SSB-MTC |

OPTIONAL, -- Need S

| | |
|---|---|
| ssb SubcarrierSpacing | SubcarrierSpacing, |

| | |
|---|---|
| ssb-ToMeasure | SSB-ToMeasure |

OPTIONAL, -- Need S

| | |
|---|---|
| deriveSSB-IndexFromCell | BOOLEAN, |

| | |
|---|---|
| ss-RSSI-Measurement | SS-RSSI-Measurement |

OPTIONAL,

| | |
|---|---|
| q-RxLevMin | Q-RxLevMin, |

| | |
|---|---|
| q-RxLevMinSUL | Q-RxLevMin |

OPTIONAL, -- Need R

| | |
|---|---|
| q-QualMin | Q-QualMin |

OPTIONAL, -- Need S

| | |
|---|---|
| p-Max | P-Max |

OPTIONAL, -- Need S

| | |
|---|---|
| t-ReselectionNR | T-Reselection, |

| | |
|---|---|
| t-ReselectionNR-SF | SpeedStateScaleFactors |

OPTIONAL, -- Need S

| | |
|---|---|
| threshX-HighP | ReselectionThreshold, |
| threshX-LowP | ReselectionThreshold, |
| threshX-Q | SEQUENCE { |

| | |
|---|---|
| threshX-HighQ | ReselectionThresholdQ, |
| threshX-LowQ | ReselectionThresholdQ |

}
OPTIONAL, -- Cond RSRQ

| | |
|---|---|
| cellReselectionPriority | CellReselectionPriority |

OPTIONAL, -- Need R

| | |
|---|---|
| cellReselectionSubPriority | CellReselectionSubPriority |

OPTIONAL, -- Need R

| | |
|---|---|
| q-OffsetFreq | Q-OffsetRange |

DEFAULT dB0,

| | |
|---|---|
| interFreqNeighCellList | InterFreqNeighCellList |

OPTIONAL, -- Need R

| | |
|---|---|
| interFreqBlackCellList | InterFreqBlackCellList |

OPTIONAL, -- Need R
...
}
InterFreqCarrierFreqInfo-v1610 ::= SEQUENCE {

| | |
|---|---|
| interFreqNeighCellList-v1610 | InterFreqNeighCellList-v1610 |

OPTIONAL, -- Need R

| | |
|---|---|
| smtc2-LP-r16 | SSB-MTC2-LP-r16 |

OPTIONAL, -- Need R

| | |
|---|---|
| interFreqWhiteCellList-r16 | InterFreqWhiteCellList-r16 |

OPTIONAL, -- Cond SharedSpectrum2

| | |
|---|---|
| ssb-PositionQCL-Common-r16 | SSB-PositionQCL-Relation-r16 |

OPTIONAL, -- Cond SharedSpectrum

| | |
|---|---|
| interFreqCAG-CellList-r16 | SEQUENCE (SIZE (1..maxPLMN)) OF |

InterFreqCAG-CellListPerPLMN-r16 OPTIONAL -- Need R
}

| | |
|---|---|
| InterFreqNeighCellList ::= | SEQUENCE (SIZE (1..maxCellInter)) OF |

InterFreqNeighCellInfo

| | |
|---|---|
| InterFreqNeighCellList-v1610 ::= | SEQUENCE (1..maxCellInter)) OF |

InterFreqNeighCellInfo-v1610

| | |
|---|---|
| InterFreqNeighCellInfo ::= | SEQUENCE { |

| | |
|---|---|
| physCellId | PhysCellId, |

| | |
|---|---|
| q-OffsetCell | Q-OffsetRange, |

| | |
|---|---|
| q-RxLevMinOffsetCell | INTEGER (1..8) |

OPTIONAL, -- Need R

| | |
|---|---|
| q-RxLevMinOffsetCellSUL | INTEGER (1..8) |

OPTIONAL, -- Need R

| | |
|---|---|
| q-QualMinOffsetCell | INTEGER (1..8) |

OPTIONAL, -- Need R
...
}

| | |
|---|---|
| InterFreqNeighCellInfo-v1610 ::= | SEQUENCE { |

| | |
|---|---|
| ssb-PositionQCL-r16 | SSB-PositionQCL-Relation-r16 |

OPTIONAL -- Cond SharedSpectrum2

| | |
|---|---|
| InterFreqBlackCellList ::= | SEQUENCE (SIZE (1..maxCellBlack)) OF PCI-Range |
| InterFreqWhiteCellList-r16 ::= | SEQUENCE (SIZE (1..maxCellWhite)) OF PCI-Range |

InterFreqCAG-CellListPerPLMN-r16 ::= SEQUENCE {

| plmn-IdentityIndex-r16 | INTEGER (1..maxPLMN), | |
|---|---|---|
| cag-CellList-r16 | | SEQUENCE (SIZE (1..maxCAG-Cell-r16)) OF |

PCI-Range
}

SIB5 may include information/parameters for reselecting an inter-RAT frequency cell by the UE. For example, one or a plurality of EUTRA frequencies may be broadcast in SIB5, and one cell reselection priority configuration information for each EUTRA frequency may be broadcast. The cell reselection priority configuration information for each EUTRA frequency refers to the above-mentioned content (for example, cellReselectionPriority and/or cellReselectionSubPriority mapped to each EUTRA frequency), but one cell reselection priority configuration information for each EUTRA frequency is optionally broadcast. Specifically, information in Table 5 below may be broadcast in SIB5.

TABLE 5

| | |
|---|---|
| SIB5 ::= | SEQUENCE { |

| | |
|---|---|
| carrierFreqListEUTRA | CarrierFreqListEUTRA |

OPTIONAL, -- Need R

| | |
|---|---|
| t-ReselectionEUTRA | T-Reselection, |

| | |
|---|---|
| t-ReselectionEUTRA-SF | SpeedStateScaleFactors |

OPTIONAL, -- Need S

| | |
|---|---|
| lateNonCriticalExtension | OCTET STRING |

```
OPTIONAL,
  ...,
  [[
```

| | |
|---|---|
| carrierFreqListEUTRA-v1610 | CarrierFreqListEUTRA-v1610 |

OPTIONAL -- Need R
]]
}

| | |
|---|---|
| CarrierFreqListEUTRA ::= | SEQUENCE (SIZE (1..maxEUTRA-Carrier)) OF |

CarrierFreqEUTRA

| | |
|---|---|
| CarrierFreqListEUTRA-v1610 ::= | SEQUENCE (SIZE (1..maxEUTRA-Carrier)) OF |

CarrierFreqEUTRA-v1610

| | |
|---|---|
| CarrierFreqEUTRA ::= | SEQUENCE { |

| | |
|---|---|
| carrierFreq | ARFCN-ValueEUTRA, |

| | |
|---|---|
| eutra-multiBandInfoList | EUTRA-MultiBandInfoList |

OPTIONAL, -- Need R

| | |
|---|---|
| eutra-FreqNeighCellList | EUTRA-FreqNeighCellList |

OPTIONAL, -- Need R

| | |
|---|---|
| eutra-BlackCellList | EUTRA-FreqBlackCellList |

OPTIONAL, -- Need R

| | |
|---|---|
| allowedMeasBandwidth | EUTRA-AllowedMeasBandwidth, |
| presenceAntennaPort1 | EUTRA-PresenceAntennaPort1, |

| | |
|---|---|
| cellReselectionPriority | CellReselectionPriority |

OPTIONAL, -- Need R

| | |
|---|---|
| cellReselectionSubPriority | CellReselectionSubPriority |

OPTIONAL, -- Need R

| | |
|---|---|
| threshX-High | ReselectionThreshold, |
| threshX-Low | ReselectionThreshold, |
| q-RxLevMin | INTEGER (−70..−22), |
| q-QualMin | INTEGER (−34..−3), |

| | |
|---|---|
| p-MaxEUTRA | INTEGER (−30..33), |

| | |
|---|---|
| threshX-Q | SEQUENCE { |

| | |
|---|---|
| threshX-HighQ | ReselectionThresholdQ, |
| threshX-LowQ | ReselectionThresholdQ |

}
OPTIONAL -- Cond RSRQ
}
CarrierFreqEUTRA-v1610 ::= SEQUENCE {

| | |
|---|---|
| highSpeedEUTRACarrier-r16 | ENUMERATED {true} |

OPTIONAL -- Need R
}

| | |
|---|---|
| EUTRA-FreqBlackCellList ::= | SEQUENCE (SIZE (1..maxEUTRA-CellBlack)) OF |

EUTRA-PhysCellIdRange

| | |
|---|---|
| EUTRA-FreqNeighCellList ::= | SEQUENCE (SIZE (1..maxCellEUTRA)) OF EUTRA- |

FreqNeighCellInfo

| | |
|---|---|
| EUTRA-FreqNeighCellInfo ::= | SEQUENCE { |

| | |
|---|---|
| physCellId | EUTRA-PhysCellId, |
| dummy | EUTRA-Q-OffsetRange, |

| | |
|---|---|
| q-RxLevMinOffsetCell | INTEGER (1..8) |

OPTIONAL, -- Need R

| | |
|---|---|
| q-QualMinOffsetCell | INTEGER (1..8) |

OPTIONAL -- Need R
}

The UE 5-01 in the RRC idle mode or RRC inactive mode may perform a cell reselection evaluation process, which refers to a series of processes of determining a reselection priority (reselection priorities handling), performing frequency measurement by applying measurement rules for cell re-selection according to the determined re-selection priority, and re-selecting cells by evaluating cell re-selection criteria accordingly.

In step 5-40, the UE 5-01 in the RRC idle mode or RRC inactive mode may derive a reselection priority, based on the system information received in step 5-25. The UE 5-01 may determine a reselection priority only for frequencies on which a cell reselection priority value is broadcast in the system information. With reference to a cell reselection priority value mapped to an NR frequency to which the serving cell on which the UE 5-01 is currently camping belongs, the UE 5-01 according to the disclosure may determine whether a cell reselection priority for each NR inter-frequency or inter-RAT frequency has the same cell reselection priority as the NR frequency to which the serving cell belongs, whether the cell reselection priority has a higher cell reselection priority than the NR frequency to which the serving cell belongs, or whether the cell reselection priority has a lower cell reselection priority than the NR frequency to which the serving cell belongs. For example, In case that it is identified that, in the system information acquired in step 5-25, a cell reselection priority value mapped to the NR frequency to which the serving cell on which the UE is currently camping belongs is 3, a cell reselection priority value of inter NR frequency 1 is 2, a cell reselection priority value of inter NR frequency 2 is 3, a cell reselection priority value of inter NR frequency 3 is 4, and a cell reselection priority value of EUTRA frequency 1 is 2, the UE 5-01 may determine the inter NR frequency 1 and EUTRA frequency 1 as a lower cell reselection priority (lower reselection priority), determine a cell reselection priority of the inter NR frequency 2 as an equal reselection priority, and determine a cell reselection priority of the inter NR frequency 3 as a higher reselection priority.

In step 5-45, the UE 5-01 in the RRC idle mode or RRC inactive mode may perform frequency measurement for cell reselection. In this case, to minimize battery consumption, the UE 5-01 may perform frequency measurement by using the following measurement rule according to the cell reselection priority determined in step 5-40.

The UE may be unable to perform NR intra-frequency measurement In case that the following condition 1 is satisfied. Otherwise, in case that the following condition 1 is not satisfied, the UE performs NR intra-frequency measurement.

Condition 1: A reception level (Srxlev) of a serving cell is greater than an SIntraSearchP threshold value and a reception quality (Squal) of the serving cell is greater than an SIntraSearchQ threshold value (Serving cell fulfils Srxlev>SIntraSearchP and Squal>SIntraSearchQ).

For an NR inter-frequency or inter-RAT frequency having a reselection priority higher than an NR frequency of the current serving cell, the UE may perform measurement according to the 3GPP TS 38.133 standard.

For an NR inter-frequency having a reselection priority lower than or equal to the NR frequency of the current serving cell, and an inter-RAT frequency having a reselection priority lower than the NR frequency of the current serving cell, the UE may be unable to perform measurement In case that the following condition 2 is satisfied. Otherwise, In case that the following condition 2 is not satisfied, the UE measures cells in the NR inter-frequency having the reselection priority lower than or equal to the NR frequency, or measures cells in the inter-RAT frequency having the reselection priority lower than the NR frequency.

Condition 2: A reception level (Srxlev) of a serving cell is greater than an SnonIntraSearchP threshold value and a reception quality (Squal) of the serving cell is greater than an SnonIntraSearchQ threshold value (Serving cell fulfils Srxlev>SnonIntraSearchP and Squal>SnonIntraSearchQ).

For reference, the above-described threshold values (SintraSearchP, SintraSearchQ, SnonIntraSearchP SnonintraSearchQ) may be broadcast in the system information acquired in step 5-25.

In step 5-50, the UE 5-01 in the RRC idle mode or the RRC inactive state may determine to reselect a cell satisfying cell reselection criteria, based on a value of the measurement performed in step 5-50. As for the cell reselection criteria, different criteria may be applied according to cell reselection priorities. In case that multiple cells satisfying the cell re-selection criteria have different cell reselection priorities, reselecting a frequency/RAT cell having a higher cell reselection priority has priority over reselecting a frequency/RAT cell having a lower priority (Cell reselection to a higher priority RAT/frequency shall take precede over a lower priority RAT/frequency if multiple cells of different priorities fulfil the cell reselection criteria). Specifically, the operations of the UE with respect to reselection criteria of an inter-frequency/inter-RAT cell having a higher priority than the frequency of the current serving cell are as follows.

### First Operation:

In case that a threshold value for threshServingLowQ is included in the SIB2 and broadcast, and 1 second has elapsed since the UE has camped on the current serving cell, if a signal quality (Squal) of the inter-frequency/inter-RAT cell is greater than a threshold value ThreshX,HighQ during a specific time TreselectionRAT (Squal>ThreshX,HighQ during a time interval TreselectionRAT), the UE reselects the corresponding inter-frequency/inter-RAT cell.

### Second Operation:

In case that the UE fails to perform the first operation, the UE performs the second operation.

In case that 1 second has elapsed since the UE has camped on the current serving cell, and a reception level (Srxlev) of the inter-frequency/inter-RAT cell is greater than a threshold value ThreshX,HighP during a specific time TreselectionRAT (Srxlev>ThreshX, HighP during a time interval TreselectionRAT), the UE reselects the corresponding inter-frequency/inter-RAT cell.

The UE performs the first operation or the second operation, based on information in which the TreselectionRAT values, the threshold values (Threh_{X, HighQ}, Thresh_{X, HighP}), the reception level (Srxlev), and the signal quality (Squal) of the inter-frequency cell are included in the SIB4 broadcast from the serving cell, and performs the first operation or the second operation, based on information in which the TreselectionRAT values, the threshold values (Thresh_{X,HighQ}, Thresh_{X, HighP}), the reception level (Srxlev), and the signal quality (Squal) of the inter-RAT cell are included in the SIB5 broadcast from the serving cell. For example, SIB4 includes a Q_{qualmin} value or a Qᵣₓₗₑᵥₘᵢₙ value, and based on the values, a signal quality (Squal) or a reception level (Srxlev) of an inter-frequency cell is derived. In case that a plurality of cells on the NR frequency satisfying a high cell reselection priority exist, the UE may reselect the highest-ranked cell from among cells satisfying reselection criteria of an intra-frequency/inter-frequency cell having the same priority as the frequency of the current serving cell described below.

In addition, the operations of the UE with respect to the reselection criteria of the intra-frequency/inter-frequency cell having the same priority as the frequency of the current serving cell are as follows.

### Third Operation:

In case that a signal quality (Squal) and a reception level (Srxlev) of the intra-frequency/inter-frequency cell are greater than 0, a rank for each cell is derived based on a measurement value (RSRP) (The UE shall perform ranking of all cells that fulfils the cell selection criterion S). Each of the ranks of the serving cell and a neighboring cell is calculated via Equation (1) below.

$${R}_{s} = {Q}_{meas , s} + {Q}_{hyst} \\ {R}_{n} = {Q}_{meas , n} - Qoffset \qquad ( 1 )$$

Q_{meas,s} is an RSRP measurement value of a serving cell, Q_{meas,n} is an RSRP measurement value of a neighboring cell, Q_{hyst} is a hysteresis value of the serving cell, and Qoffset is an offset between the serving cell and the neighboring cell. A Q_{hyst} value is included in the SIB2, and the corresponding value is commonly used for reselection of the intra-frequency/inter-frequency cell. In reselection of the intra-frequency cell, Qoffset is signaled for each cell, is applied only to an indicated cell, and is included in the SIB3. In reselection of the inter-frequency cell, Qoffset is signaled for each cell, is applied only to an indicated cell, and is included in the SIB4. In case that the rank of a neighboring cell, obtained by Equation 1 above, is greater than the rank of the serving cell (Rn>Rs), the corresponding neighboring cell is reselected as an optimal cell among neighboring cells.

In addition, the operations of the UE with respect to reselection criteria of an inter-frequency/inter-RAT cell having a lower priority than the frequency of the current serving cell are as follows.

### Fourth Operation:

In case that a threshold value for threshServingLowQ is included in the SIB2 and broadcast, and 1 second has elapsed since the UE has camped on the current serving cell, if a signal quality (Squal) of the current serving cell is less than a threshold value ThreshServing, LowQ (Squal<ThreshServing, LowQ) and a signal quality (Squal) of the inter-frequency/inter-RAT cell is greater than a threshold value ThreshX, LowQ during a specific time interval TreselectionRAT (Squal>ThreshX,LowQ during a specific time interval TreselectionRAT), the UE reselects the corresponding inter-frequency/inter-RAT cell.

### Fifth Operation:

In case that the UE fails to perform the fourth operation, the UE performs the fifth operation. In case that one second has elapsed since the UE has camped on the current serving cell, a reception level (Srxlev) of the current serving cell is less than a threshold value ThreshServing, LowP (Srxlev<ThreshServing, LowP), and a reception level (Srxlev) of the inter-frequency/inter-RAT cell is greater than a threshold value ThreshX, LowQ during a specific time interval TreselectionRAT (Srxlev>ThreshX, LowP during a time interval TreselectionRAT), the UE reselects the corresponding inter-frequency/inter-RAT cell.

The fourth operation or the fifth operation for the inter-frequency cell of the UE is performed based on the threshold values (Thresh_{Serving, LowQ}, Thresh_{Serving, LowP}) included in the SIB2 broadcast from the serving cell, and the TreselectionRAT, the threshold values (Threh_{X, LowQ}, Thresh_{X, LowP}), the reception level (Srxlev), and the signal quality (Squal) of the inter-frequency cell, which are included in SIB4 broadcast from the serving cell. The fourth operation or the fifth operation for the inter-RAT cell of the UE is performed based on the threshold values (Thresh_{Serving, LowQ}, Thresh_{Serving, LowP}) included in the SIB2 broadcast from the serving cell, and the TreselectionRAT, the threshold values (Thresh_{X,LowQ}, Thresh_{X, LowP}), the reception level (Srxlev), and the signal quality (Squal) of the inter-RAT cell, which are included in the SIB5 broadcast from the serving cell. For example, SIB4 includes a Q_{qualmin} value or a Qᵣₓₗₑᵥₘᵢₙ value, and based on the values, the signal quality (Squal) or the reception level (Srxlev) of the inter-frequency cell is derived. In case that a plurality of cells on the NR frequency satisfying a high cell reselection priority exist, the UE may reselect the highest-ranked cell from among cells satisfying reselection criteria of an intra-frequency/inter-frequency cell having the same priority as the frequency of the current serving cell described below. In case that the above conditions are satisfied on a frequency with a higher or lower priority than the frequency of the current serving cell and one candidate cell is derived, the UE may reselect the best cell (strongest cell).

In step 5-55, the UE 5-01 in the RRC idle mode or the RRC inactive state receives system information (for example, MIB or SIB1) broadcast from a candidate target cell before finally reselecting the candidate target cell, and determines whether a reception level (Srxlev) and a reception quality (Squal) of the candidate target cell fulfill a cell selection criterion called S-criterion (first expression) (Srxlev>0 AND Squal>0), based on the received system information. In case that the first expression is satisfied and the candidate target cell is suitable, the UE 5-01 may reselect the candidate target cell.

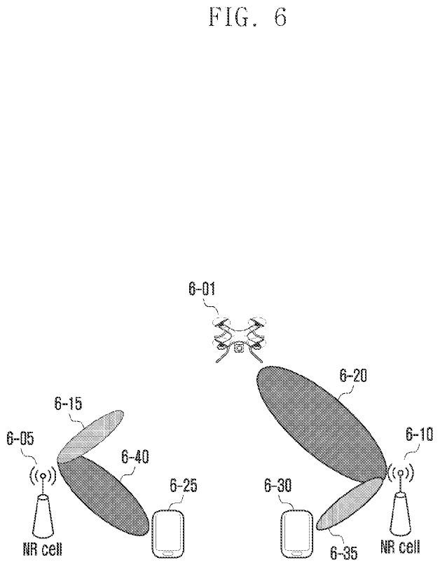

FIG. 6 illustrates a method in which a UAV UE and a ground UE access a cell employing beam uptilting and a cell employing beam downtilting in a next-generation mobile communication system according to an embodiment.

A UAV UE 6-01 is a terminal capable of flying in the sky. In other words, the UAV UE 6-01, which is located at or above a specific height, may receive signals from NR cells 6-05 and 6-10 (indicated by reference numerals 6-15 and 6-20). In this case, the NR cell 6-10 employing beam uptilting may allow accessing of the UAV UE 6-01, while the NR cell 6-05 employing beam downtilting may not allow accessing of the UAV UE 6-01 (e.g., via cellBarredUAV in SIB1). In other words, the NR cell 6-10 employing beam uptilting may be a dedicated cell operated for the UAV UE.

The ground UEs 6-25 and 6-30 may receive signals from the NR cells 6-05 and 6-10 (indicated by reference numerals 6-35 and 6-40). In this case, the NR cell 6-05 employing beam downtilting may allow accessing of the ground UEs 6-25 and 6-30, while the NR cell 6-10 employing beam uptilting may not allow accessing of the ground UEs 6-25 and 6-30 (e.g., via cellBarred in MIB). In other wors, the NR cell 6-05 employing beam downtilting may be a dedicated cell operated for the ground UEs. The ground UEs 6-25 and 6-30 may be UAV UEs, but may be referred to as ground UEs if they are located on the ground or below a specific height.

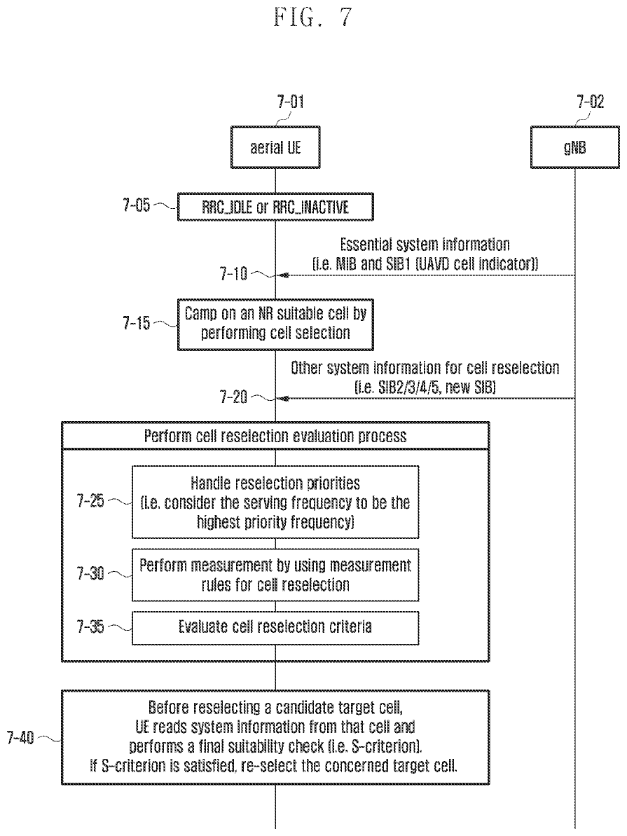

FIG. 7 illustrates an aerial UE performing a cell reselection procedure in a next-generation mobile communication system according to an embodiment.

The UE 7-01 may be referred to as an aerial UE. In an example, the aerial UE may refer to a terminal capable of flying, such as a terminal having a UAV function, or a terminal having an urban aerial mobility (UAM) function. In other words, the aerial UE may receive service support from a base station while flying at a specific height.

Referring to FIG. 7, in step 7-05, an aerial UE 7-01 may be in an RRC idle mode (RRC_IDLE) or RRC inactive mode (RRC_INACTIVE) because the UE has not established an RRC connection with an NR base station 7-02.

In step 7-10, the aerial UE 7-01 in the RRC idle mode or RRC inactive mode may acquire essential system information. The essential system information may refer to an MIB and an SIB1. The disclosure sets forth a broadcast an indicator indicating a dedicated cell for the aerial UE (a UAV dedicated cell, hereinafter, referred to as a UAVD cell) via SIB1. The indicator may be referred to as, but is not limited to, a UAVD cell indicator and may not only be an explicit indicator indicating the UAVD cell, but may also be a parameter for supporting the UAVD. For example, In case that a parameter for supporting the UAVD is included in SIB1, the UE 7-01 may identify that the cell is a UAVD cell.

In step 7-15, the aerial UE 7-01 in the RRC idle mode or RRC inactive mode may perform a cell selection procedure to camp-on an NR suitable cell.

In step 7-20, the UE 7-01 in the RRC idle mode or RRC inactive mode may obtain system information (e.g., SIB2, SIB3, SIB4, SIB5, and new SIB) containing cell reselection information from the serving cell 7-02 to perform a cell reselection evaluation procedure. This may be similar to the foregoing embodiment.

The aerial UE 7-01 in the RRC idle mode or RRC inactive mode may perform a cell reselection evaluation procedure, which may refer to a series of processes of determining a reselection priority (reselection priorities handling), performing frequency measurement by applying measurement rules for cell re-selection according to the determined re-selection priority, and re-selecting cells by evaluating cell re-selection criteria accordingly.

In step 7-25, the aerial UE 7-01 in the RRC idle mode or RRC inactive mode may derive a reselection priority, based on the system information received in step 7-20. The UE 7-01 may determine a reselection priority only for frequencies on which a cell reselection priority value is broadcast in the system information. The UE 7-01 may, In case that SIB1 includes a UAVD cell indicator, determine the reselection priority by considering to be the highest priority frequency the same frequency to which the current serving cell belongs (considering the serving frequency to be the highest priority frequency) (e.g., a serving frequency, a frequency of the serving cell, a frequency band of the serving cell, the same frequency as the frequency to which the serving cell belongs). Since UAVD cells are likely to operate on the same frequency to which the serving cell belongs, the highest reselection priority is given to the same frequency to which the serving cell currently belongs, and the probability that the UE can reselect the UAVD cell may increase.

In step 7-30, the aerial UE 7-01 in the RRC idle mode or RRC inactive mode may perform frequency measurements for cell reselection. The aerial UE 7-01 may perform the frequency measurement by using the measurement rule of the foregoing embodiment according to the cell reselection priority determined in step 7-25 to minimize battery consumption.

In step 7-35, the aerial UE 7-01 in the RRC idle mode or RRC inactive state may determine to reselect cells satisfying the cell reselection criteria, based on a value of the measurement performed in step 7-30. This may be based on the foregoing embodiments.

In step 7-40, the aerial UE 7-01 in the RRC idle mode or the RRC inactive state receives system information (for example, MIB or SIB1) broadcast from a candidate target cell before finally reselecting the candidate target cell, and determines whether a reception level (Srxlev) and a reception quality (Squal) of the candidate target cell fulfill a cell selection criterion called S-criterion (first expression) (Srxlev>0 AND Squal>0), based on the received system information. In case that the first expression is satisfied and the candidate target cell is suitable, the UE 7-01 may reselect the candidate target cell. Alternatively, while the above-mentioned details are satisfied, the UE may reselect the target cell only in case that the UAVD indicator is included in SIB1 obtained from the target cell.

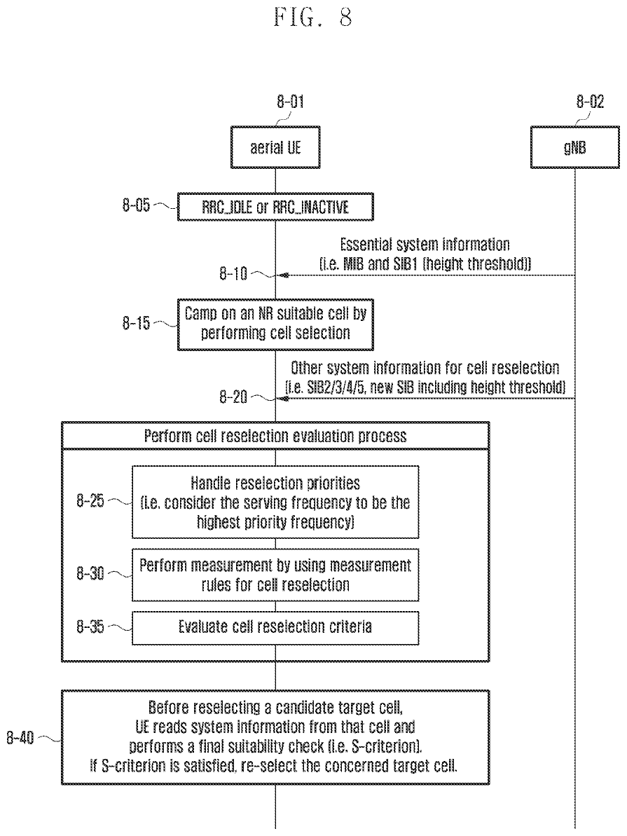

FIG. 8 illustrates an aerial UE performing a cell reselection procedure in a next-generation mobile communication system according to an embodiment.

Referring to FIG. 8, in step 8-05, an aerial UE 8-01 may be in an RRC idle mode (RRC_IDLE) or RRC inactive mode (RRC_INACTIVE) because the UE has not established an RRC connection with an NR base station 8-02.

In step 8-10, the aerial UE 8-01 in the RRC idle mode or RRC inactive mode may acquire essential system information. The essential system information may refer to an MIB and SIB1. SIB1 may include information indicating a height threshold. In other words, the UE 8-01 may be unable to camp on a corresponding cell In case that the UE flies at or below the height threshold. In this case, In case that the UE 8-01 camps on the corresponding cell, the UE may perform an operation according to at least one of the foregoing embodiments. For reference, the height threshold may be a value determined internally by the UE or may be a value configured via an RRC release message.

In step 8-15, the aerial UE 8-01 in the RRC idle mode or RRC inactive mode may perform a cell selection procedure to camp-on an NR suitable cell.

In step 8-20, the UE 8-01 in the RRC idle mode or RRC inactive mode may obtain system information (e.g., SIB2, SIB3, SIB4, SIB5, and new SIB) containing cell reselection information from the serving cell 8-02 to perform a cell reselection evaluation procedure. The system information may further include information indicating a height threshold. For example, the new SIB may further include information indicating a height threshold.

The aerial UE 8-01 in the RRC idle mode or RRC inactive mode may perform a cell reselection evaluation procedure, which may refer to a series of processes of determining a reselection priority (reselection priorities handling), performing frequency measurement by applying measurement rules for cell re-selection according to the determined re-selection priority, and re-selecting cells by evaluating cell re-selection criteria accordingly.

In step 8-25, the aerial UE 8-01 in the RRC idle mode or RRC inactive mode may derive a reselection priority, based on the system information received in step 8-20. The UE 8-01 may determine a reselection priority only for frequencies on which a cell reselection priority value is broadcast in the system information. The UE 8-01 may, In case that flying at or above the height threshold, determine the reselection priority by considering to be the highest priority frequency the same frequency to which the current serving cell belongs (considering the serving frequency to be the highest priority frequency) (e.g., a serving frequency, a frequency of the serving cell, a frequency band of the serving cell, the same frequency as the frequency to which the serving cell belongs). Accordingly, a UE flying at or above a specific height has the advantage of efficiently controlling interference by causing cell reselection to occur within the same frequency to which the serving cell belongs. In case that the UE 8-01 flies at or below the height threshold, the UE may determine the reselection priority according to at least one of the foregoing embodiments.

In step 8-30, the aerial UE 8-01 in the RRC idle mode or RRC inactive mode may perform frequency measurements for cell reselection by using the measurement rule of the foregoing embodiment according to the cell reselection priority determined in step 8-25 to minimize battery consumption.

In step 8-35, the aerial UE 8-01 in the RRC idle mode or RRC inactive state may determine to reselect cells satisfying the cell reselection criteria, based on a value of the measurement performed in step 8-30.

In step 8-40, the aerial UE 8-01 in the RRC idle mode or the RRC inactive state receives system information (for example, MIB or SIB1) broadcast from a candidate target cell before finally reselecting the candidate target cell, and determines whether a reception level (Srxlev) and a reception quality (Squal) of the candidate target cell fulfill a cell selection criterion called S-criterion (first expression) (Srxlev>0 AND Squal>0), based on the received system information. In case that the first expression is satisfied and the candidate target cell is suitable, the UE 8-01 may reselect the candidate target cell.

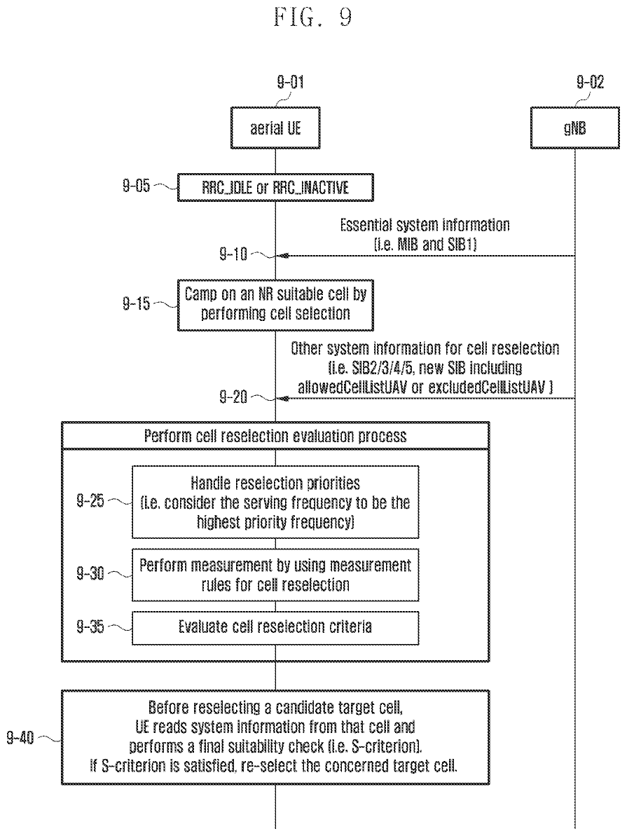

FIG. 9 illustrates an aerial UE performing a cell reselection procedure in a next-generation mobile communication system according to an embodiment.

Referring to FIG. 9, in step 9-05, an aerial UE 9-01 may be in an RRC idle mode (RRC_IDLE) or RRC inactive mode (RRC_INACTIVE) because the UE has not established an RRC connection with an NR base station 9-02.

In step 9-10, the aerial UE 9-01 in the RRC idle mode or RRC inactive mode may acquire essential system information. The essential system information may refer to an MIB and SIB1. The information contained in the SIB1 may be based on at least one of the foregoing embodiments.

In step 9-15, the aerial UE 9-01 in the RRC idle mode or RRC inactive mode may perform a cell selection procedure to camp-on an NR suitable cell.

In step 9-20, the UE 9-01 in the RRC idle mode or RRC inactive mode may obtain system information (e.g., SIB2, SIB3, SIB4, SIB5, and new SIB) containing cell reselection information from the serving cell 9-02 to perform a cell reselection evaluation procedure. It is disclosed herein that a list of allowed UAVD cells or a list of excluded UAVD cells on the same frequency to which the current serving cell belongs is broadcast in the system information. In other words, the allowed UAVD cell list may refer to a list of cells for which the aerial UE 9-01 is capable of cell reselection, and the excluded UAVD cell list may refer to a list of cells for which the aerial UE 9-01 is incapable of cell reselection. For reference, the aerial UE 9-01 may perform cell reselection evaluation only for the allowed UAVD cell list and may be unable to perform cell reselection evaluation for the excluded UAVD cell list. Alternatively, the aerial UE 9-01 may apply the details above only In case that flying at or above a specific height threshold. For reference, cell reselection parameters mapped to the above cell list may also be broadcast. The cell reselection parameters are parameters that are used In case that deriving the S criterion or R criterion and may refer to separately added parameters in the above-described embodiment or to scaling parameters in the above-described embodiment.

The aerial UE 9-01 in the RRC idle mode or RRC inactive mode may perform a cell reselection evaluation procedure, which may refer to a series of processes of determining a reselection priority (reselection priorities handling), performing frequency measurement by applying measurement rules for cell re-selection according to the determined re-selection priority, and re-selecting cells by evaluating cell re-selection criteria accordingly.

In step 9-25, the aerial UE 9-01 in the RRC idle mode or RRC inactive mode may derive a reselection priority, based on the system information received in step 9-20. The UE 9-01 may determine a reselection priority only for frequencies on which a cell reselection priority value is broadcast in the system information.

In step 9-30, the aerial UE 9-01 in the RRC idle mode or RRC inactive mode may perform frequency measurements for cell reselection. The aerial UE 9-01 may perform the frequency measurement by using the measurement rule of the foregoing embodiment according to the cell reselection priority determined in step 9-25 to minimize battery consumption.

In step 9-35, the aerial UE 9-01 in the RRC idle mode or RRC inactive state may determine to reselect cells satisfying the cell reselection criteria, based on a value of the measurement performed in step 9-30. The aerial UE 9-01 may determine cells to be reselected through at least one of the following.

The UE may reselect a cell with the highest rank from among cells in the allowed UAVD cell list or from among cells except for the cells in the excluded UAVD cell list.

Reselecting a highest-ranked cell by the UE may refer to a case in which the corresponding cell is one of cells, except for the cells in the allowed UAVD cell list or the cells in the excluded UAVD cell list. In case that the highest-ranked cell does not satisfy the above condition, the corresponding frequency may be excluded.

In case that UE reselects a highest-ranked cell, In case that the corresponding cell refers to cells, except for the cells in the allowed UAVD cell list or the cells in the excluded UAVD cell list, the UE may reselect the corresponding cell. Otherwise, the UE may reselect the highest-ranked cell on the corresponding frequency.

In step 9-40, the aerial UE 9-01 in the RRC idle mode or RRC inactive state receives system information (e.g., MIB or SIB1) broadcast from a candidate target cell before finally reselecting the candidate target cell, and determines, based on the received system information, whether the reception level (Srxlev) and reception quality (Squal) of the candidate target cell fulfill a cell selection criterion referred to as the S-criterion (first expression) (Srxlev>0 AND Squal>0). The UE 9-01 may reselect the candidate target cell In case that the first expression is satisfied and the candidate target cell is suitable.

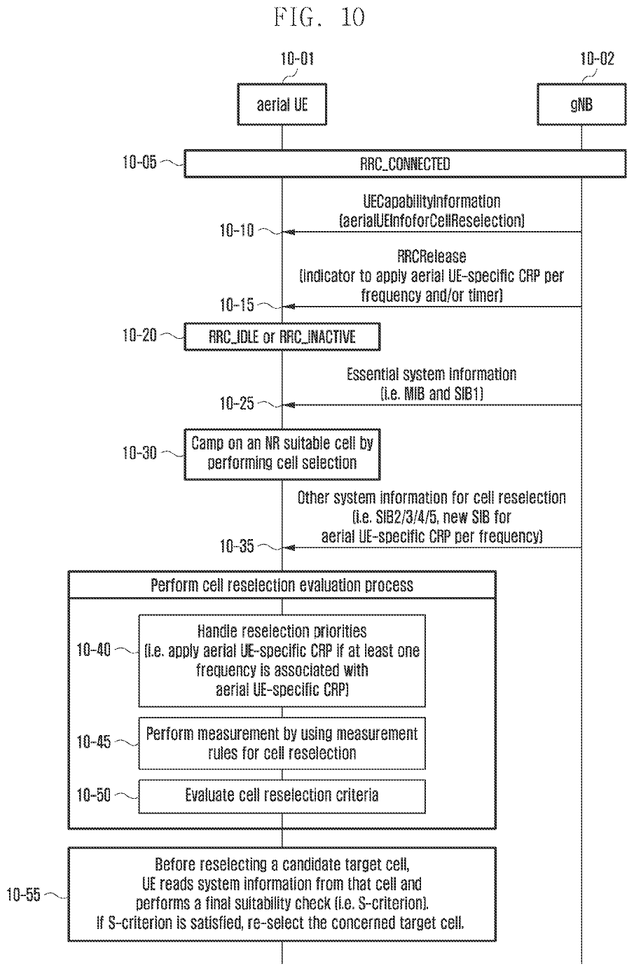

FIG. 10 illustrates an aerial UE performing a cell reselection procedure in a next-generation mobile communication system according to an embodiment.

Referring to FIG. 10, in step 10-05, an aerial UE 10-01 may be in an RRC connected mode (RRC_CONNECTED) by establishing an RRC connection with an NR base station 10-02.

In step 10-10, the aerial UE 10-01 may transmit a UE capability information message (UECapabilityInformation) to an NR base station 10-02. The message may include an indicator (aerialUEInfoforCellReselection) indicating whether the aerial UE is capable of applying a cell reselection priority for the aerial UE broadcast in the system information in the RRC idle mode (RRC_IDLE) or RRC inactive mode (RRC_INACTIVE).

In step 10-15, the NR base station 10-02 may transmit an RRC release message (RRCRelease) to the aerial UE 10-01. The message may include at least one of an indicator indicating whether to apply a frequency-specific or NR frequency-specific aerial UE cell reselection priority (CRP) and information on a timer. The information on the timer may include a value of a new timer such as a value of a T320 timer (or a value of a conventional T320 timer). The UE 10-01 may drive the timer with a configured timer value. In case that the driven timer expires or stops, the UE 10-01 may release the new indicator and apply a cell reselection priority according to at least one of the foregoing embodiments. In case that the RRC mode changes, that a public land mobile network (PLMN) or a standalone non-public network (SNPN) is selected by a higher layer device, and even that the RRC release message does not include the information, the UE may release the new indicator and/or stop the driven timer.

In step 10-20, upon receiving the RRCRelease, the aerial UE 10-01 may transition to the RRC idle mode or RRC inactive mode. Specifically, In case that receiving an RRCRelease containing suspend configuration information (suspendConfig), the UE may transition to the RRC inactive mode, otherwise the UE may transition to the RRC idle mode.

In step 10-25, the aerial UE 10-01 in the RRC idle mode or RRC inactive mode may acquire essential system information, including a master information block (MIB) and system information block 1 (SIB1).

In step 10-30, the aerial UE 10-01 in the RRC idle mode or RRC inactive mode may perform a cell selection procedure to camp-on an NR suitable cell.

In step 10-35, the UE 10-01 in the RRC idle mode or RRC inactive mode may obtain system information (e.g., SIB2, SIB3, SIB4, SIB5, new SIB) containing cell reselection information from the serving cell 10-02 to perform a cell reselection evaluation procedure. The serving cell disclosed herein broadcasts one or two cell reselection priority (CRP) values for each frequency.

In SIB2, at least one of a first CRP (legacy CRP) and a second CRP (CRP for aerial UE) of a serving frequency may be broadcast.

In SIB4, at least one of a first CRP (legacy CRP) and a second CRP (CRP for aerial UE) per NR inter-frequency may be broadcast.

In SIB5, at least one of a first CRP (legacy CRP) and a second CRP (CRP for aerial UE) per E-UTRAN frequency may be broadcast.

If the second CRP (CRP for aerial UEs) is not broadcast in the above system information, a frequency-specific second CRP (CRP for aerial UE) may be broadcast in new SIB.

The above system information or the new system information may also include a height threshold.

The CRP may include at least one of a CellReselectionPriority information element (IE) and an IE of a CellReselectionSubPriority. The CellReselectionPriority IE may contain an integer value (e.g., an integer value of one of 0 to 7), and the CellReselectionSubPriority IE may contain a decimal value (e.g., a decimal value of one of 0.2, 0.4, 0.6, and 0.8). In case that only one of the two IEs is signaled, the UE 10-01 may derive a cell reselection priority value from the signaled value, and In case that both IEs are signaled, the UE 10-01 may derive the cell reselection priority value by adding the two signaled values.

The aerial UE 10-01 in the RRC idle mode or RRC inactive mode may perform a cell reselection evaluation procedure, which may refer to a series of processes of determining a reselection priority (reselection priorities handling), performing frequency measurement by applying measurement rules for cell re-selection according to the determined re-selection priority, and re-selecting cells by evaluating cell re-selection criteria accordingly.

In step 10-40, the aerial UE 10-01 in the RRC idle mode or RRC inactive mode may derive a reselection priority based on the system information received in step 10-35. The UE may determine the reselection priority only for frequencies on which a cell reselection priority value is broadcast in the system information. The UE 10-01 determines the reselection priority by applying the second CRP In case that the frequency-specific second CRP is broadcast, and by applying the frequency-specific first CRP otherwise. Specifically, In case that only the second CRP is broadcast on a specific frequency, or In case that both the first CRP and the second CRP are broadcast thereon, the UE 10-01 may apply the second CRP to determine the reselection priority. In case that only the first CRP is broadcast on a specific frequency, the UE 10-01 may apply the first CRP to determine the reselection priority. In case that a second CRP is broadcast on a specific frequency, the UE 10-01 may ignore the first CRP on all frequencies. The method by which the UE 10-01 derives the frequency-specific reselection priority may be based on the foregoing embodiments. The aerial UE 10-01 may be allowed to apply separate CRPs on specific frequencies, so as to control interference in the downlink or uplink, or control cell load. For reference, the above example may be applied only In case that the RRC release message includes the above-mentioned indicator or may be applied even In case that the RRC release message does not include the above-mentioned indicator.

In step 10-45, the aerial UE 10-01 in the RRC idle mode or RRC inactive mode may perform frequency measurements for cell reselection. The aerial UE 10-01 may perform the frequency measurement by using the measurement rule of the foregoing embodiment according to the cell reselection priority determined in step 10-40 to minimize battery consumption. In step 10-50, the aerial UE 10-01 in the RRC idle mode or RRC inactive state may determine to reselect cells satisfying the cell reselection criteria, based on a value of the measurement performed In step 10-45. This may be based on the foregoing embodiments.

A list of cells that the aerial UE 10-01 is able to reselect (e.g., a list of allowed UAVD cells) is broadcast and thus only cells belonging to the broadcast cell list may be re-selected. A list of cells that the aerial UE 10-01 is unable to reselect (e.g., a list of excluded UAVD cells) is broadcast and thus only cells that do not belong to the broadcast cell list may be re-selected. A parameter (e.g., Qoffset) applied to Equation (1) above may be separately broadcast in the system information, and the UE 10-01 may apply the parameter to perform cell ranking. In case that the best or highest-ranked cell is not included in the list of allowed UAVD cells or is included in the list of excluded UAVD cells, the UE 10-01 may exclude the frequency to which the corresponding cell belongs. The foregoing details applies only In case that the UE 10-01 is flying at or above a height threshold, and thus cell reselection may be performed.

In step 10-55, the aerial UE 10-01 in the RRC idle mode or the RRC inactive state receives system information (for example, MIB or SIB1) broadcast from a candidate target cell before finally reselecting the candidate target cell, and determines whether a reception level (Srxlev) and a reception quality (Squal) of the candidate target cell fulfill a cell selection criterion referred to as S-criterion (first expression)(Srxlev>0 AND Squal>0), based on the received system information. In case that the first expression is satisfied and the candidate target cell is suitable, the UE 10-01 may reselect the candidate target cell.

While FIGS. 7, 8, 9, and 10 have been described respectively, it is also possible to merge and carry out at least two of the embodiments of FIGS. 7, 8, 9, and 10. For example, In case that the embodiments of FIGS. 7 and 8 are merged, the UAVD cell indicator and height threshold may be considered as being provided via the SIB, and in this case, the operations performed via FIGS. 7 and 8 may be performed together. For example, the embodiments of FIGS. 7 and 8 may be merged with the embodiment of FIG. 9. In this case, the UAVD cell indicator, the height threshold, the allowed cell list UAV, or the excluded cell list UAV may be considered together. For example, the embodiments of FIGS. 7, 8, and 9 may be merged with step 10-20 and subsequent steps of FIG. 10.

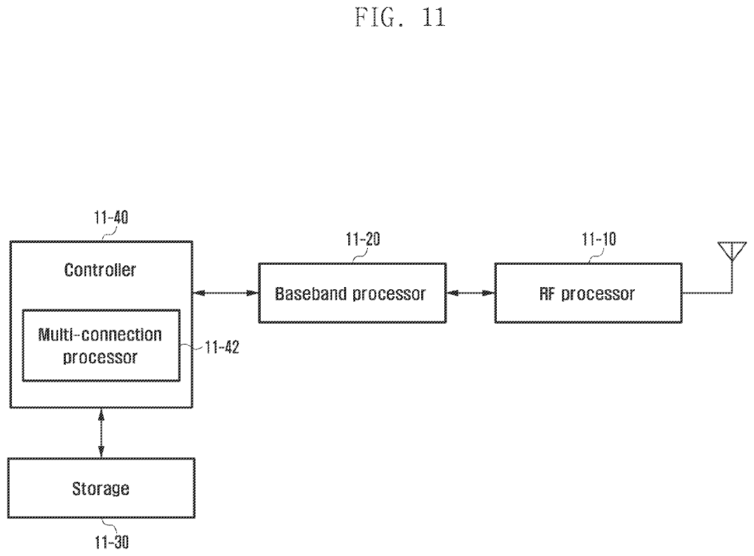

FIG. 11 illustrates a configuration of a terminal according to an embodiment.

Referring to FIG. 11, the terminal includes a radio frequency (RF) processor 11-10, a baseband processor 11-20, a storage 11-30, and a controller 11-40. The controller 11-40 may include a multi-connection processor 11-42.

The RF processor 11-10 performs functions for transmitting and receiving signals via a radio channel, such as frequency band conversion and amplification of signals. In other words, the RF processor 11-10 up-converts baseband signals provided by the baseband processor 11-20 into RF band signals and transmits the RF band signals through an antenna, and down-converts RF band signals received through the antenna into baseband signals. For example, the RF processor 11-10 may include a transmission filter, a reception filter, an amplifier, a mixer, an oscillator, a digital to analog converter (DAC), an analog to digital converter (ADC), and the like. In FIG. 11, only one antenna is shown, but the terminal may have multiple antennas. The RF processor 11-10 may include a plurality of RF chains. The RF processor 11-10 may perform beamforming. For the beamforming, the RF processor 11-10 may adjust the phase and magnitude of each of the signals transmitted and received through the plurality of antennas or antenna elements. In addition, the RF processor may perform MIMO, and may receive multiple layers in the case of performing MIMO operation.

The baseband processors 11-20 perform conversion functions between baseband signals and bit strings according to the physical layer standards of the system. In case that transmitting data, the baseband processor 11-20 generates complex symbols by encoding and modulating the transmitted bit string. In case that data is received, the baseband processor 11-20 restores the received bit string by demodulating and decoding the baseband signal supplied from the RF processor 11-10. For example, according to the OFDM scheme, In the case of transmitting data, the baseband processor 11-20 generates complex symbols by encoding and modulating a transmission bit string, maps the complex symbols to subcarriers, and then performs an inverse fast Fourier transform (IFFT) operation and cyclic prefix (CP) insertion to configure OFDM symbols. In case that data is received, the baseband processor 11-20 divides the baseband signal supplied from the RF processor 11-10 into OFDM symbol units and restores signals mapped to the subcarrier by a fast Fourier transform (FFT) operation, and then restores the received bit string through modulation and decoding.

The baseband processor 11-20 and the RF processor 11-10 transmit and receive signals as described above. Accordingly, the baseband processor 11-20 and the RF processor 11-10 may be referred to as a transmitter, receiver, transceiver or communication unit. Furthermore, at least one of the baseband processor 11-20 and the RF processor 11-10 may include a plurality of communication modules to support a plurality of different radio access technologies. In addition, at least one of the baseband processor 11-20 and the RF processor 11-10 may include different communication modules to process signals in different frequency bands. For example, different radio access technologies may include a wireless LAN (e.g., IEEE 802.11), a cellular network (e.g., LTE), etc. The different frequency bands may include a super-high frequency (SHF) (e.g., 2.NRHz, NRhz) frequency band, a millimeter wave (e.g., 60 GHz) frequency band.

The storage 11-30 stores data such as basic programs, application programs, and configuration information for the operation of the terminal. In particular, the storage 11-30 may store information associated with a second access node performing wireless communication using a second access technology. The storage 11-30 provides the stored data according to the request of the controller 11-40.

The controller 11-40 controls the overall operations of the terminal. For example, the controller 11-40 transmits and receives a signal through the baseband processor 11-20 and the RF processor 11-10. The controller 11-40 records and reads data in and from the storage 11-30. To this end, the controller 11-40 may include at least one processor. For example, the controller 11-40 may include a communication processor (CP) performing a control for communication and an application processor (AP) for controlling a higher layer such as the application programs.

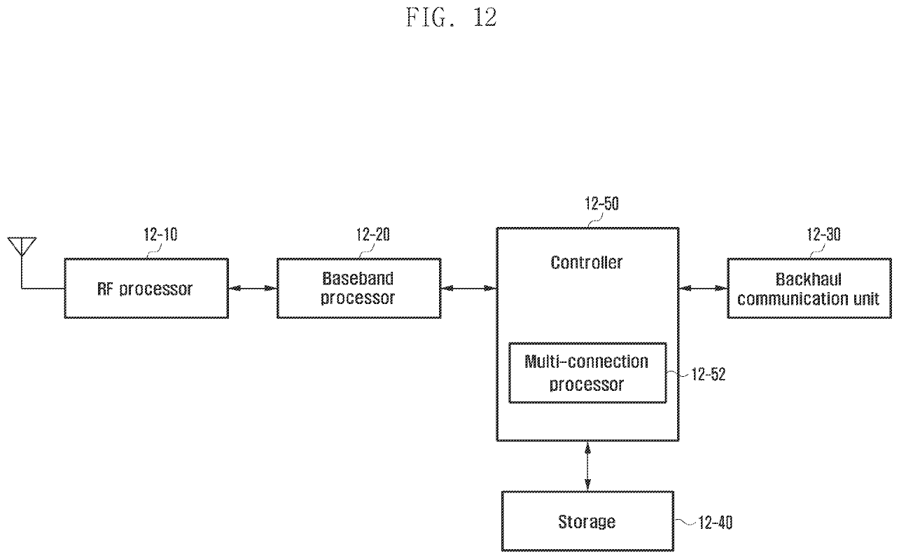

FIG. 12 illustrates a configuration of a base station according to an embodiment.

As illustrated in FIG. 12, the base station is configured to include an RF processor 12-10, a baseband processor 12-20, a backhaul communication unit 12-30, a storage 12-40, and a controller 12-50. The controller 12-50 may include a multi-connection processor 12-52.

The RF processor 12-10 serves to transmit and receive signals through a radio channel, such as band conversion and amplification of signals. In other words, the RF processor 12-10 up-converts a baseband signal provided from the baseband processor 12-20 into an RF band signal and then transmits the RF band signal through an antenna and down-converts the RF band signal received through the antenna into the baseband signal. For example, the RF processor 12-10 may include a transmission filter, a reception filter, an amplifier, a mixer, an oscillator, a DAC, an ADC, or the like. In FIG. 12, only one antenna is illustrated, but the first access node may include a plurality of antennas. The RF processor 12-10 may include a plurality of RF chains. The RF processor 12-10 may perform beamforming, in which the RF processor 12-10 may adjust a phase and a size of each of the signals transmitted/received through a plurality of antennas or antenna elements. The RF processor may perform a downward MIMO operation by transmitting one or more layers.

The baseband processor 12-20 performs a conversion function between the baseband signal and the bit string according to the physical layer standard of the first radio access technology. For example, In case that data is transmitted, the baseband processor 12-20 generates complex symbols by coding and modulating a transmitted bit string. In case that data is received, the baseband processor 12-20 restores the received bit string by demodulating and decoding the baseband signal provided from the RF processor 12-10. For example, according to the OFDM scheme, In case that data is transmitted, the baseband processor 12-20 generates the complex symbols by coding and modulating the transmitting bit string, maps the complex symbols to the sub-carriers, and then performs the IFFT operation and the CP insertion to configure the OFDM symbols. In case that data is received, the baseband processor 12-20 divides the baseband signal provided from the RF processor 12-10 to OFDM symbol units and restores the signals mapped to the sub-carriers by the FFT operation and then restores the received bit string through the modulation and decoding. The baseband processor 12-20 and the RF processor 12-10 transmit and receive a signal as described above. Therefore, the baseband processor 12-20 and the RF processor 12-10 may be called a transmitter, a receiver, a transceiver, or a communication unit.

The backhaul communication unit 12-30 provides an interface for performing communication with other nodes within the network. In other words, the backhaul communication unit 12-30 converts bit strings transmitted from the main base station to other nodes, for example, an auxiliary base station, a core network, etc., into physical signals and converts the physical signals received from other nodes into the bit strings.

The storage 12-40 stores data such as basic programs, application programs, and configuration information for the operation of the main base station. In particular, the storage 12-40 may store the information on the bearer allocated to the accessed terminal, the measured results reported from the accessed terminal, etc. The storage 12-40 may store information that is a determination criterion on whether to provide a multiple connection to the terminal or stop the multiple connection to the terminal. The storage 12-40 provides the stored data according to the request of the controller 12-50.

The controller 12-50 controls the general operations of the main base station. For example, the controller 12-50 transmits/receives a signal through the baseband processor 12-20 and the RF processor 12-10 or the backhaul communication unit 12-30. The controller 12-50 records and reads data in and from the storage 12-40. To this end, the controller 12-50 may include at least one processor.

The methods according to various embodiments described in the claims or the specification of the disclosure may be implemented by hardware, software, or a combination of hardware and software.

In case that the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. A plurality of such memories may be included in the electronic device.

In addition, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device via an external port. A separate storage device on the communication network may access a portable electronic device.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in the reverse order, depending upon the functionality involved.

While this disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by an uncrewed aerial vehicle (UAV) terminal in a wireless communication system, the method comprising:
receiving first system information;
camping on a first cell supporting a UAV based on the first system information, in case that an altitude of the UAV terminal is greater than an altitude threshold;
receiving, from the first cell, second system information including cell reselection information;
determining a cell reselection priority based on a frequency identical to a first frequency of the first cell and the cell reselection information included in the second system information; and
performing a measurement based on the cell reselection priority.

2. The method of claim 1,
wherein the UAV terminal considers the frequency as a highest priority frequency for a cell reselection.

3. The method of claim 1,
wherein the first system information includes information for identifying whether the first cell is a UAV dedicated cell.

4. The method of claim 1,
wherein the second system information includes at least one of a first cell list allowed for the UAV or a second cell list excluded for the UAV, and
wherein a cell for the cell reselection is determined based on at least one of the first cell list or the second cell list.

5. A method performed by a base station supporting an uncrewed aerial vehicle (UAV) in a wireless communication system, the method comprising:
broadcasting first system information including information on an altitude threshold of a first cell of the base station; and
broadcasting second system information including cell reselection information,
wherein the information on the altitude threshold is used for a UAV terminal at an altitude higher than the altitude threshold to camp on the first cell, and
wherein a cell reselection priority is determined based on a frequency identical to a first frequency of the first cell and the cell reselection information included in the second system information.

6. The method of claim 5,
wherein the frequency is considered as a highest priority frequency for a cell reselection.

7. The method of claim 5,
wherein the first system information includes information for identifying whether the first cell is a UAV dedicated cell.

8. The method of claim 5,
wherein the second system information includes at least one of a first cell list allowed for the UAV or a second cell list excluded for the UAV, and
wherein a cell for the cell reselection is determined based on at least one of the first cell list or the second cell list.

9. An uncrewed aerial vehicle (UAV) terminal in a wireless communication system, the UAV terminal comprising:
a transceiver; and
a controller configured to:
receive first system information,
camp on a first cell supporting a UAV based on the first system information, in case that an altitude of the UAV terminal is greater than an altitude threshold,
receive, from the first cell, second system information including cell reselection information,
determine a cell reselection priority based on a frequency identical to a first frequency of the first cell and the cell reselection information included in the second system information, and
perform a measurement based on the cell reselection priority.

10. The UAV terminal of claim 9,
wherein the UAV terminal considers the frequency as a highest priority frequency for a cell reselection.

11. The UAV terminal of claim 9,
wherein the first system information includes information for identifying whether the first cell is a UAV dedicated cell.

12. The UAV terminal of claim 9,
wherein the second system information includes at least one of a first cell list allowed for the UAV or a second cell list excluded for the UAV, and
wherein a cell for the cell reselection is determined based on at least one of the first cell list or the second cell list.

13. A base station supporting an uncrewed aerial vehicle (UAV) in a wireless communication system, the base station comprising:
a transceiver; and
a controller configured to:
broadcast first system information including information on an altitude threshold of a first cell of the base station, and
broadcast second system information including cell reselection information,
wherein the information on the altitude threshold is used for a UAV terminal at an altitude higher than the altitude threshold to camp on the first cell, and
wherein a cell reselection priority is determined based on a frequency identical to a first frequency of the first cell and the cell reselection information included in the second system information.

14. The method of claim 13,
wherein the frequency is considered as a highest priority frequency for a cell reselection.

15. The method of claim 13,
wherein the first system information includes information for identifying whether the first cell is a UAV dedicated cell,
wherein the second system information includes at least one of a first cell list allowed for the UAV or a second cell list excluded for the UAV, and
wherein a cell for the cell reselection is determined based on at least one of the first cell list or the second cell list.
